(19) United States
(12) Patent Application Publication
(10) Pub. No.: US 2017/0090703 A1
(43) Pub. Date: Mar. 30, 2017

(54) METHOD OF AND SYSTEM FOR INTERACTING WITH A CONTENT ELEMENT OF A CONTENT STREAM

(71) Applicant: YANDEX EUROPE AG, Luzern (CH)

(72) Inventor: Roman Rufikovich ISKANDAROV, Moscow (RU)

(21) Appl. No.: 15/263,493

(22) Filed: Sep. 13, 2016

(30) Foreign Application Priority Data
Sep. 29, 2015 (RU) 2015141291

(51) Int. Cl. G06F 3/0483; G06F 3/0485; G06F 3/041

(52) U.S. Cl. CPC G06F 3/0483; G06F 3/0416; G06F 3/0485

(57) ABSTRACT

A computer-implemented method of and a system for interacting with a content element of a content stream. The method comprises displaying, on a screen of an electronic device comprising touch hardware, a first displayable page of the content element; receiving a gesture input via the touch hardware, the gesture input being along a first direction perpendicular to a scrolling direction of the content stream; and causing, by a processing unit, the display, on the screen of the electronic device, of a visual transition from the first displayable page of the content element to a second displayable page of the content element, the second displayable page defining a back side of the content element, the visual transition comprising a rotation from the first displayable page to the second displayable page, the rotation being about an axis extending in a second direction aligned with the scrolling direction of the content stream.

### CROSS-REFERENCE

The present application claims priority to Russian Patent Application No. 2015141291, filed Sep. 29, 2015, entitled “METHOD OF AND SYSTEM FOR INTERACTING WITH A CONTENT ELEMENT OF A CONTENT STREAM”, the entirety of which is incorporated herein by reference.

### FIELD

The present technology relates to electronic devices, and more particularly, to electronic devices that enable users to interact with a content element of a content stream, for example, but without being limited to, in a context of allowing the users to provide feedback associated with the content element.

### BACKGROUND

Various global or local communication networks (the Internet, the World Wide Web, local area networks and the like) offer a user a vast amount of information. The information includes a multitude of contextual topics, such as but not limited to, news and current affairs, maps, company information, financial information and resources, traffic information, games and entertainment related information. Users use a variety of client devices (desktop, laptop, notebook, smartphone, tablets and the like) to have access to rich content (like images, audio, video, animation, and other multimedia content from such networks).

The volume of available information through various Internet resources has grown exponentially in the past couple of years. Several solutions have been developed in order to allow a typical user to find the information that the user is looking for. One example of such a solution is a search engine. Examples of the search engines include Google™ search engine, Yandex™ search engine, Yahoo!™ search engine and the like. The user can access the search engine interface and submit a search query associated with the information that the user is desirous of locating on the Internet. In response to the search query, the search engine provides a ranked list of search results. The ranked list of search results is generated based on various ranking algorithms employed by the particular search engine that is being used by the user performing the search. The overall goal of such ranking algorithms is to present the most relevant search results at the top of the ranked list, while less relevant search results would be positioned on less prominent positions of the ranked list of search results (with the least relevant search results being located towards the bottom of the tanked list of search results).

The search engines typically provide a good search tool for a search query that the user knows apriori that she/he wants to search. In other words, if the user is interested in obtaining information about the most popular destinations in Italy (i.e. a known search topic), the user could submit a search query: “The most popular destinations in Italy?” The search engine will then present a ranked list of Internet resources that are potentially relevant to the search query. The user can then browse the ranked list of search results in order to obtain information she/he is interested in as it related to places to visit in Italy. If the user, for whatever reason, is not satisfied with the uncovered search results, the user can re-run the search, for example, with a more focused search query, such as “The most popular destinations in Italy in the summer?”, “The most popular destinations in the South of Italy?”, “The most popular destinations for a romantic getaway in Italy?”.

There is another approach that has been proposed for allowing the user to discover content and, more precisely, to allow for discovering and/or recommending content that the user may not be expressly interested in searching for. In a sense, such systems recommend content to the user without an express search request based on explicit or implicit interests of the user.

An example of such a system is a Flipboard™ recommending system, which system aggregates and recommends content from various social networks. The Flipboard™ recommending system presents the uncovered content in a “magazine style” format, where the user can “flip” through the pages with the recommended/aggregated content. The recommending system collects content from social media and other websites, presents it in magazine format, and allows users to “flip” through their social-networking feeds and feeds from websites that have partnered with the company, effectively “recommending” content to the user even though the user may not have expressly expressed her/his desire in the particular content.

As a person skilled in the art of the present technology may appreciate, a quality of a user experience may not be solely defined by how relevant information content may be to a given user. Accordingly, how the information content is presented to a user may also be an important aspect of the user experience. In some instances, how the information content is presented to a user may be appreciated independently of how the information has been generated, selected and/or recommended. Multiple approaches as to how the information content is presented to a user via an electronic device have been developed. For example, a web browser may present information content based on an HTML coding of a webpage. As another example, information content aggregating applications such as Facebook™, LinkedIn™ and Twitter™ can present information content according to one or more predefined templates. As a quantity of information content that can be presented to the user is virtually limitless attends have been to provide users with more intuitive navigational access to the information content.

One such attend is detailed in U.S. Pat. No. 8,935,629 to Flipboard™ wherein systems and methods enable users to flip through displayed pages. In particular, a displayed page may be flipped along a rotational axis so as to enable graphical animations for transitioning from one page to another page in a way that portions of three or more pages can be simultaneously viewed by a user. Even though such approach provides benefits it may present limits, at least under certain conditions, for example, but without being limited to, when a user is presented an opportunity to provide feedback associated with information content.

### SUMMARY

Developers of the present technology have appreciated certain technical drawbacks associated with the existing systems and methods of presenting content to a user and allowing a user to interact with a content element of a content stream. It is an object of the present technology to ameliorate at least some of the inconveniences present in the prior art, in particular by limiting a number of interactions required by a user to provide feedback in a way that (1) limit a number of gestures a user has to physically conduct with an electronic device; and (2) limit disrupting a navigation experience of the user with the content stream.

The present technology arises from an observation made by the inventor(s) that a content element of a content stream may be associated with a first displayable page and a second displayable page, the first displayable page being associated with a front side of the content element and the second displayable page being associated with a first back side of the content element. A first input from a user causes a first visual transition comprising a first rotation about an axis extending in a first direction aligned with the scrolling direction of the content stream occurs. The first visual transition allows transitioning from the first displayable page to the second displayable page. In some embodiments of the present technology, a second input from the user causes a second visual transition comprising a second rotation about the axis. The second visual transition allows transitioning from the first displayable page to a third displayable page. In some embodiments, the user input comprises a gesture input via a touch hardware of an electronic device, the gesture being along a direction perpendicular to a scrolling direction of the content stream.

The present technology thereby results, amongst other benefits, in an improved navigation experience by limiting a number of interactions required by the user to interact with a content stream, for example, but without being limited to, while providing feedback in connection with a given content element of the content stream. The limited number of interactions may result in (1) reducing a number of gestures a user has to physically conduct with an electronic device; (2) reducing disruption of a navigation experience of the user while interacting with the content stream; and/or (3) more intuitive interaction of the user with the content stream through the electronic device.

Thus, in one aspect, various implementations of the present technology provide a computer-implemented method of interacting with a content element of a content stream, the method comprising:
displaying, on a screen of an electronic device, a first displayable page of the content element, the first displayable page defining a front side of the content element;
receiving, from a user, via the electronic device, a first input; and
causing, by a processing unit, as a result of the first input, the display, on the screen of the electronic device, of a first visual transition from the first displayable page of the content element to a second displayable page of the content element, the second displayable page defining a first back side of the content element, the first visual transition comprising a first rotation from the first displayable page to the second displayable page, the first rotation being about an axis extending in a second direction aligned with the scrolling direction of the content stream, the first rotation being along a first rotational direction along the axis.

In some embodiments, the method further comprises:
receiving, from the user, via the electronic device, a second input, different from the first input; and
causing, by the processing unit, as a result of the second input, the display, on the screen of the electronic device, of a second visual transition from the first displayable page of the content element to a third displayable page of the content element, the third displayable page defining a second back side of the content element, the second visual transition comprising a second rotation from the first displayable page to the third displayable page, the second rotation being along a second rotational direction along the axis, the second rotational direction being opposite the first rotational direction.

In yet another aspect, various implementations of the present technology provide a computer-implemented method of interacting with a content element of a content stream, the method comprising:
displaying, on a screen of an electronic device comprising touch hardware, a first displayable page of the content element, the first displayable page defining a front side of the content element;
receiving, from a user, a gesture input via the touch hardware, the gesture input being along a first direction to a scrolling direction of the content stream; and
causing, by a processing unit, the display, on the screen of the electronic device, of a visual transition from the first displayable page of the content element to a second displayable page of the content element, the second displayable page defining a back side of the content element, the visual transition comprising a rotation from the first displayable page to the second displayable page, the rotation being about an axis extending in a second direction aligned with the scrolling direction of the content stream.

In yet another aspect, various implementations of the present technology provide a computer-implemented method of interacting with a content element of a content stream, the method comprising:

displaying, on a screen of an electronic device, a first displayable page of the content element, the first displayable page defining a front side of the content element;

receiving, from a user, via the electronic device, a first input;

causing, by a processing unit, as a result of the first input, the display, on the screen of the electronic device, of a first visual transition from the first displayable page of the content element to a second displayable page of the content element, the second displayable page defining a first back side of the content element;

receiving, from a user, via the electronic device, a second input different from the first input; and

causing, by the processing unit, as a result of the second input, the display, on the screen of the electronic device, of a second visual transition from the first displayable page of the content element to a third displayable page of the content element, the third displayable page defining a second back side of the content element.

In other aspects, various implementations of the present technology provide a non-transitory computer-readable medium storing program instructions for interacting with a content element of a content stream, the program instructions being executable by a processor of a computer-based system to carry out one or more of the above-recited methods.

In other aspects, various implementations of the present technology provide a computer-based system, such as, for example, but without being limitative, an electronic device comprising at least one processor and a memory storing program instructions for interacting with a content element of a content stream, the program instructions being executable by one or more processors of the computer-based system to carry out one or more of the above-recited methods.

In the context of the present specification, unless expressly provided otherwise, a “computer system”, an “electronic device”, a “mobile device”, “a device”, a “server”, a, “remote server”, and a “computer-based system” are any hardware and/or software appropriate to the relevant task at hand. Thus, some non-limiting examples of hardware and/or software include computers (servers, desktops, laptops, netbooks, etc.), smartphones, tablets, network equipment (routers, switches, gateways, etc.) and/or combination thereof.

In the context of the present specification, unless expressly provided otherwise, the expression “computer-readable medium” and “memory” are intended to include media of any nature and kind whatsoever, non-limiting examples of which include RAM, ROM, disks (CD-ROMs, DVDs, floppy disks, hard disk drives, etc.), USB keys, flash memory cards, solid state-drives, and tape drives.

In the context of the present specification, unless expressly provided otherwise, an “indication” of an information element may be the information element itself or a pointer, reference, link, or other indirect mechanism enabling the recipient of the indication to locate a network, memory, database, or other computer-readable medium location from which the information element may be retrieved. For example, an indication of a document could include the document itself (i.e. its contents), or it could be a unique document descriptor identifying a file with respect to a particular file system, or some other means of directing the recipient of the indication to a network location, memory address, database table, or other location where the file may be accessed. As one skilled in the art would recognize, the degree of precision required in such an indication depends on the extent of any prior understanding about the interpretation to be given to information being exchanged as between the sender and the recipient of the indication. For example, if it is understood prior to a communication between a sender and a recipient that an indication of an information element will take the form of a database key for an entry in a particular table of a predetermined database containing the information element, then the sending of the database key is all that is required to effectively convey the information element to the recipient, even though the information element itself was not transmitted as between the sender and the recipient of the indication.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a diagram of a computer system suitable for implementing the present technology and/or being used in conjunction with implementations of the present technology;

FIG. 2 is a diagram of a networked computing environment in accordance with an embodiment of the present technology;

FIG. 3 is a diagram of a first content stream displayed on an electronic device in accordance with an embodiment of the present technology;

FIG. 4 is a diagram of a second content stream displayed on an electronic device in accordance with an embodiment of the present technology;

FIG. 5 is a diagram of a first visual transition in accordance with an embodiment of the present technology;

FIG. 6 is a diagram of a second visual transition in accordance with an embodiment of the present technology;

FIGS. 7-10 are diagrams of snapshots taken during a first visual transition in accordance with an embodiment of the present technology;

FIGS. 11-14 are diagrams of snapshots taken during a second visual transition in accordance with an embodiment of the present technology;

FIG. 15 is a diagram of a first back side of a first alternative content element in accordance with an embodiment of the present technology;

FIG. 16 is a diagram of a second back side of the first alternative content element of FIG. 15 in accordance with an embodiment of the present technology;

FIGS. 17 and 18 are diagrams illustrating a removal of a content element from a content stream in accordance with an embodiment of the present technology;

FIGS. 19 and 20 are diagrams illustrating gestures defining various inputs from a user in accordance with embodiments of the present technology;

FIGS. 21-22 are diagrams illustrating an alternative approach for a user to provide inputs in accordance with embodiments of the present technology;

FIGS. 23-29 are diagrams illustrating various embodiments of content elements and various states of such content elements in accordance with embodiments of the present technology;

FIG. 30 is a diagram illustrating a flowchart illustrating a first computer-implemented method implementing embodiments of the present technology;

FIG. 31 is a diagram illustrating a flowchart illustrating a second computer-implemented method implementing embodiments of the present technology; and

FIG. 32 is a diagram illustrating a flowchart illustrating a third computer-implemented method implementing embodiments of the present technology.

It should also be noted that, unless otherwise explicitly specified herein, the drawings are not to scale.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

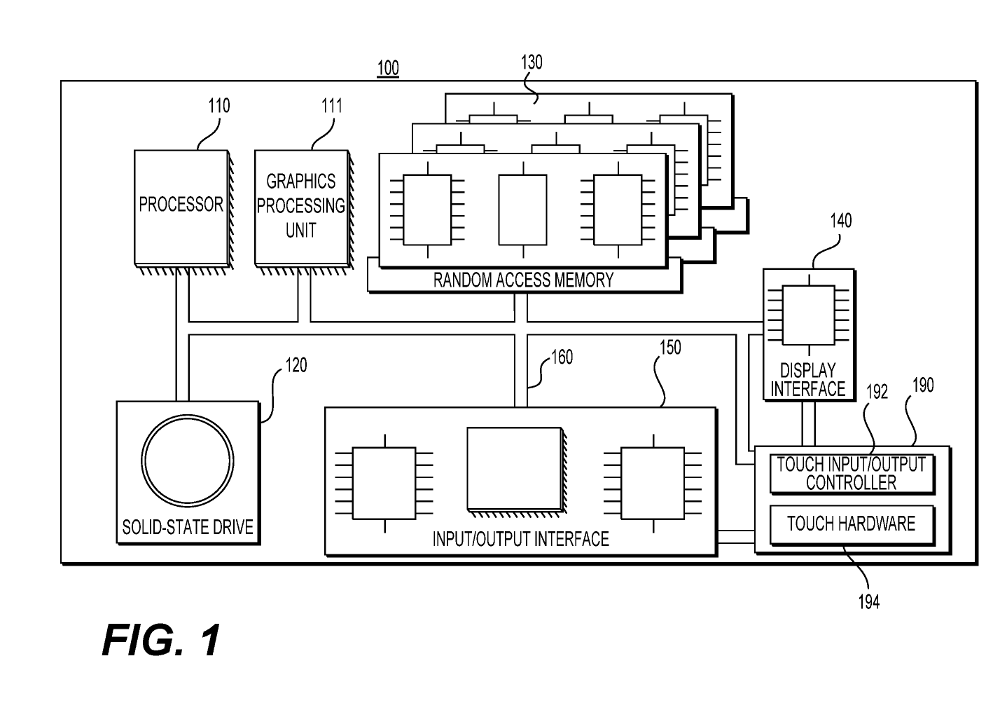

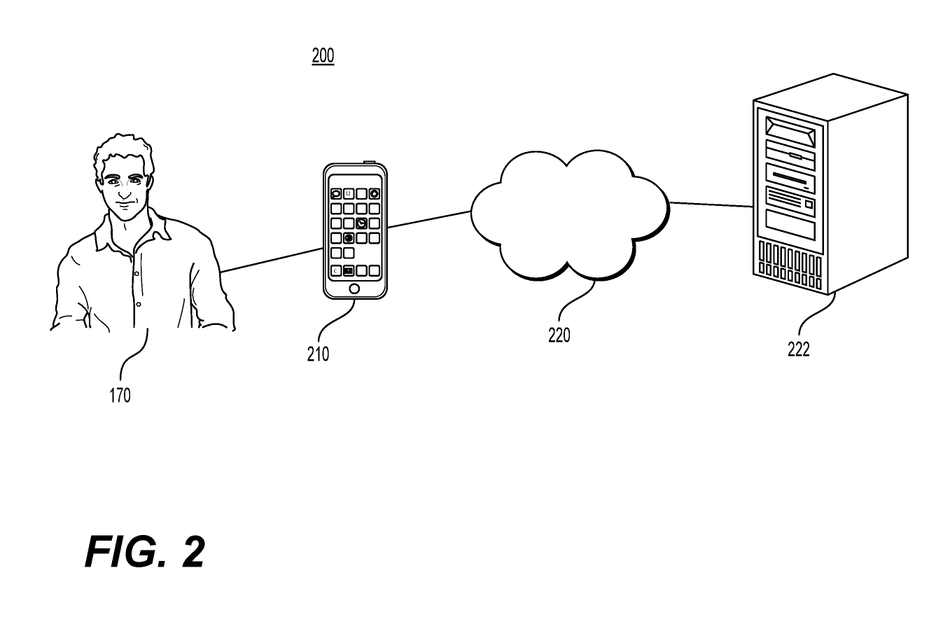

Referring to FIG. 1, there is shown a computer system 100 suitable for use with some implementations of the present technology. In some embodiments, the computer system 100 implements an electronic device 210 (shown at FIG. 2) and/or a server 222 (also shown at FIG. 2). The computer system 100 comprises various hardware components including one or more single or multi-core processors collectively represented by processor 110, a graphics processing unit (GPU) 111, a solid-state drive 120, a random access memory 130, a display interface 140, and an input/output interface 150. The computer system 100 may be a smartphone such as, but not limited to, an iPhone™ from Apple or Galaxy™ from Samsung. The computer system 100 may also be a tablet, such as, but not limited to, an iPad™ from Apple or Galaxy Tab™ from Samsung. As previously mentioned in the sections above, the computer system 100 may be, amongst other things, be an “electronic device”, a “mobile device”, “a device”, a “server”, a, “remote server”, and a “computer-based system” are any hardware and/or software appropriate to the relevant task at hand. As a person in the art of the present technology may appreciate, multiple variations as to how the computer system 100 is implemented may be envisioned without departing from the scope of the present technology.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, ARINC bus, etc.), to which the various hardware components are electronically coupled. A display interface 140 may be coupled to a display (not shown) via a cable or a bus. The display may also equally be referred to as a screen.

The input/output interface 150 may be coupled to a touchscreen 190 and/or to the one or more internal and/or external buses 160. The touchscreen 190 may be part of the display. In some embodiments, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computer system 100 in addition or in replacement of the touchscreen 190.

According to implementations of the present technology, the solid-state drive 120 stores program instructions suitable for being loaded into the random access memory 130 and executed by the processor 110 and/or the GPU 111 for allowing a user to interact with a content element of a content stream by executing a content stream display application. In some embodiments, the content stream display application may equally be referred to as a recommendation application. For example, the program instructions may be part of a library or an application.

Generally speaking, the purpose of the content stream display application is to enable the user to interact (or otherwise visualize) with a content stream stored in a memory of the computer system 100, as will be described in greater detail herein below.

How the content stream display application is implemented is not particularly limited. One example of the content stream display application may include a user accessing a web site associated with a service, such as, but not limited to, a recommendation service, to access the content stream display application. For example, the content stream display application can be accessed by typing in (or otherwise copy-pasting or selecting a link) an URL associated with the service. Alternatively, the content stream display application can be an app downloaded from a so-called app store, such as, but not limited to, an App Store™ from Apple and/or Google Play™ from Google and installed/executed on the computer system 100. It should be expressly understood that the content stream display application can be accessed using any other suitable means.

Turning now to FIG. 2, there is shown a networked computing environment 200 suitable for use with some implementations of the present technology, the networked computing environment 200 comprises an electronic device 210 associated with a user 170. In some embodiments, the electronic device 210 is implemented so as to include at least some of the components of the computer system 100. Throughout the present document, the electronic device 210 may equally be referred to as the computer system 100 and vice-versa. The networked computing environment 200 may comprise a server 222 in communication with the electronic device 210 via a network 220. The networked computing environment 200 may contain more servers and/or more electronic devices without departing from the scope of the present technology. The number of servers and the type of architecture is therefore not limitative to the scope of the present technology.

In one embodiment, a communication channel (not depicted) between the electronic device 210 and the server 222 may be established to allow data exchange. Such data exchange may occur on a continuous basis or, alternatively, upon occurrence of certain events. For examples, in the context of (i) generating content to be presented to the user 170; and/or (ii) receiving feedback associated with one or more content elements from the user 170. In some embodiments, the server 222 may generate data, such as, but not limited to, data allowing content elements to be presented to the user 170. The data generated by the server 222 may be transmitted to the electronic device 210. Once received, the data may be processed by the electronic device 210 so as to create a content stream to be presented on the screen 190 of the electronic device 210. In some embodiments, the user 170, through the electronic device 210, may provide feedback and/or cause an action in connection with one or more content elements of the content stream. As a result, the electronic device 210 may transmit data relating to such feedback and/or action to the server 222. The server 222, upon receiving the data from the electronic device 210 may undertake additional actions, such as a storing of the received data and/or an update of a profile associated with the user 170 and stored on the server 222.

The server 222 may be implemented as a conventional computer server and may comprise some or all of the features of the computer system 100 depicted at FIG. 1. In an example of an embodiment of the present technology, the server 222 can be implemented as a Dell™ PowerEdge™ Server running the Microsoft™ Windows Server™ operating system. Needless to say, the server 222 can be implemented in any other suitable hardware and/or software and/or firmware or a combination thereof. In the depicted non-limiting embodiment of present technology, the server 222 is a single server. In alternative non-limiting embodiments of the present technology, the functionality of the server 222 may be distributed and may be implemented via multiple servers.

The implementation of the server 222 is well known to the person skilled in the art of the present technology. However, briefly speaking, the server 222 comprises a communication interface (not depicted) structured and configured to communicate with various entities (such as the electronic device 210, for example and other electronic devices potentially coupled to the network) via the network. The server 222 further comprises at least one computer processor (e.g., a processor 110 of the server 222) operationally connected with the communication interface and structured and configured to execute various processes. Merely as an example and not as a limitation, in those embodiments of the present technology where the electronic device 210 is implemented as a wireless communication device (such as a smartphone or a tablet), the communication link can be implemented as a wireless communication link (such as but not limited to, a 3G communication network link, a 4G communication network link, Wireless Fidelity, or WiFi® for short, Bluetooth® and the like). In those examples where the electronic device 210 is implemented as a notebook computer, the communication link can be either wireless (such as Wireless Fidelity, or WiFi® for short, Bluetooth® or the like) or wired (such as an Ethernet based connection). As a person skilled in the art of the present technology may appreciate, multiple variations may be envisioned without departing from the scope of the present technology.

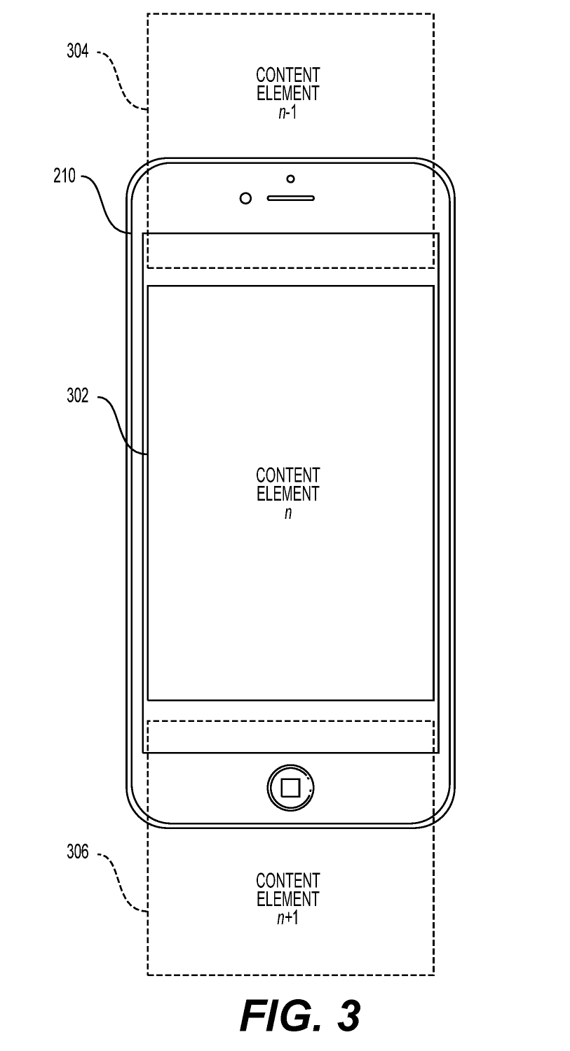

Reference is now made to FIG. 3 wherein a content stream is, at least partially, displayed on the electronic device 210 for example via a content stream display application running on the electronic device 210. The content stream of FIG. 3 comprises a content element 302. In order to facilitate understanding of how the content stream is structured and how a user may interact with the content stream, the content element 302 is represented as a content element n. A previous content element 304 and a next content element 306 are also represented. The previous content element 304 is represented as a content element n−1. The next content element 306 is represented as a content element n+1. As a person skilled in the art of the present technology may appreciate, the content elements 302, 304, 306 are aligned so as to define a vertical content stream when a user, for example the user 170, holds the electronic device 210. The content element 302 is defined by a rectangle positioned so that it is entirely displayed on the screen of the electronic device 210. As a result, the content element 302 may be defined as being an active content element as it is entirely visible to the user 170. In addition, the user 170 may also interact with the content element 302, for example to provide feedback associated with the content element 302 and/or to cause an action in relation with the content element 302.

In the example of FIG. 3, a bottom portion of the content element 304 and a top portion of the content element 306 are also visible. In some embodiments, even though the content elements 304 and 306 are not entirely visible to the user 170, the user 170 may still interact with the content elements 304 and 306 in a similar way than she/he would have had with the content element 302. In some embodiments, the user 170 may interact with the content stream by completing a swiping gesture on the screen of the electronic device 210. The swiping gesture may be oriented from bottom to top (with respect to a point of view of a user holding the electronic device 210 vertically) so as to cause a first visual transition resulting in the content element 306 to be displayed (partially or entirely) instead of the content element 302. Conversely, a swiping gesture oriented from top to bottom causes a second visual transition resulting in the content element 304 to be displayed (partially or entirely) instead of the content element 302. As a result, in some embodiments, the user 170 may navigate through multiple content elements forming the content stream by scrolling the content stream in a first direction and/or a second direction, the first direction and the second direction being, in the embodiment illustrated at FIG. 3, along a vertical direction (e.g., upward direction and downward direction). Other variations as to how the user 170 may interact with the content stream may also be envisioned without departing from the scope of the present technology, including embodiments wherein the user 170 interacts the content stream and/or the content elements 302, 304, 306 through interfaces of the electronic devices 210 other than the screen 190 (for example, via a keyboard, a mouse, vocal commands, visual comments . . . ).

In some embodiments, the content stream may be organized so that the content elements are organized in a particular fashion, for example, but without being limitative, in a chronological order or in a priority order. As an example, the content element 302 may be associated with current information, the content element 304 may be associated with older information and the content element 306 will be associated with newer information. Other variations as to how the content elements may be ordered may be envisioned without departing from the scope of the present technology, including an embodiment wherein the content elements are simply not organized in any fashion.

In some embodiments, the content stream display application running on the electronic device 210 may be a content aggregator type of application capable of sourcing media content from any suitable number of data sources. In some embodiments, the sourcing is directly conducted by the electronic device 210. In some alternative embodiments, the sourcing is conducted by the server 222 and/or jointly by the electronic device 210 and the server 222. The sourced media content may be processed by the electronic device 210 and/or the server 222 to generated content elements, such as the content elements 302, 304, 306. In some embodiments, such media content may be referred to as media asset. The sourced content may be any suitable media such as, for example, printed media, video media and/or audio media. In such embodiments, the content stream may define a media asset feed. In some alternative embodiments, the content elements may be generated from other resources, for example from one or more social networks. Other variations may also be envisioned as to what type of information and/or source of information may be used to generate the content elements without departing from the scope of the present technology.

In some embodiments, each one of the content elements 302, 304, 306 comprises information which allows the user 170 to determine whether she/he wishes to learn more about a topic associated with the information. For example, one of the content elements 302, 304, 306 may represent a succinct article. When viewed by the user 170, the one of the content elements 302, 304, 306 comprises enough information so that the user 170 is enable to make a judgment as to whether she/he wants to take an action in connection with the one of content elements 302, 304, 306.

In some embodiments, the information allows the user 170 to determine whether she/he wishes to provide feedback. In some other embodiments, the information allows the user 170 to determine whether she/he wishes to share the content element or the information associated with the content element to other individuals. For example, the user 170, upon reading the information associated with one of the content elements 302, may wish to share the content element or the information associated with the content element on social networks such as, but not limited to Facebook™ or Twitter™.

In yet some alternative embodiments, the content element may be divided in portions, each one of the portions being associated with a different media asset and/or a different piece of information and/or a different type of information. Alternatively, multiple media assets and/or pieces of information and/or types of information may be presented on a single content element. Multiple variations and arrangements may be therefore envisioned without departing from the scope of the present technology.

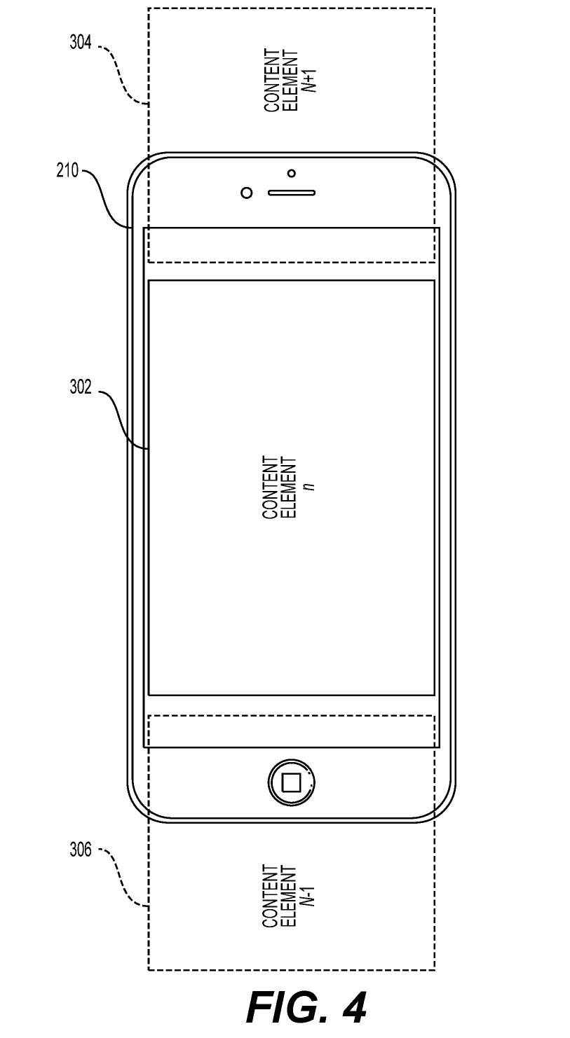

Turning now to FIG. 4, there is shown an alternative content stream in accordance with some alternative embodiments of the present technology. As for the embodiment illustrated in FIG. 3, the content stream is, at least partially, displayed on the electronic device 210 for example via a content stream display application running on the electronic device 210. As a person skilled in the art of the present technology may appreciate, the content stream illustrated in FIG. 4 differs from the content stream illustrated in FIG. 3 by its orientation. In particular, the content stream extends from a left side to a right side when the user 170 holds the electronic device in a horizontal position. As a result, the user 170 may scroll through the content stream by a swiping gesture from a left side to a right side (with respect to a point of view of a user holding the electronic device 210 horizontally) to cause a first visual transition displaying the content element 306 instead of the content element 302. Alternatively, the user 170 may scroll through the content stream by a swiping gesture form a right side to a left side to cause a second visual transition displaying the content element 304 instead of the content element 302.

Although not illustrated, other variations as to how a content stream may be oriented are also contemplated as being within the scope of the present technology. One such alternative embodiment comprises a content stream comprising content elements to be displayed horizontally when the user 170 holds the electronic device 210 in the horizontal position. In such embodiments, the user 170 may scroll through the content stream by a swiping gesture from top to bottom (with respect to a point of view of a user holding the electronic device 210 vertically) to cause a first visual transition displaying the content element 304 instead of the content element 302. Alternatively, the user 170 may scroll through the content stream by a swiping gesture form bottom to top to cause a second visual transition displaying the content element 306 instead of the content element 302. Other variations are also possible and may be envisioned by the person skilled in the art of the present technology without departing from the scope of the present technology.

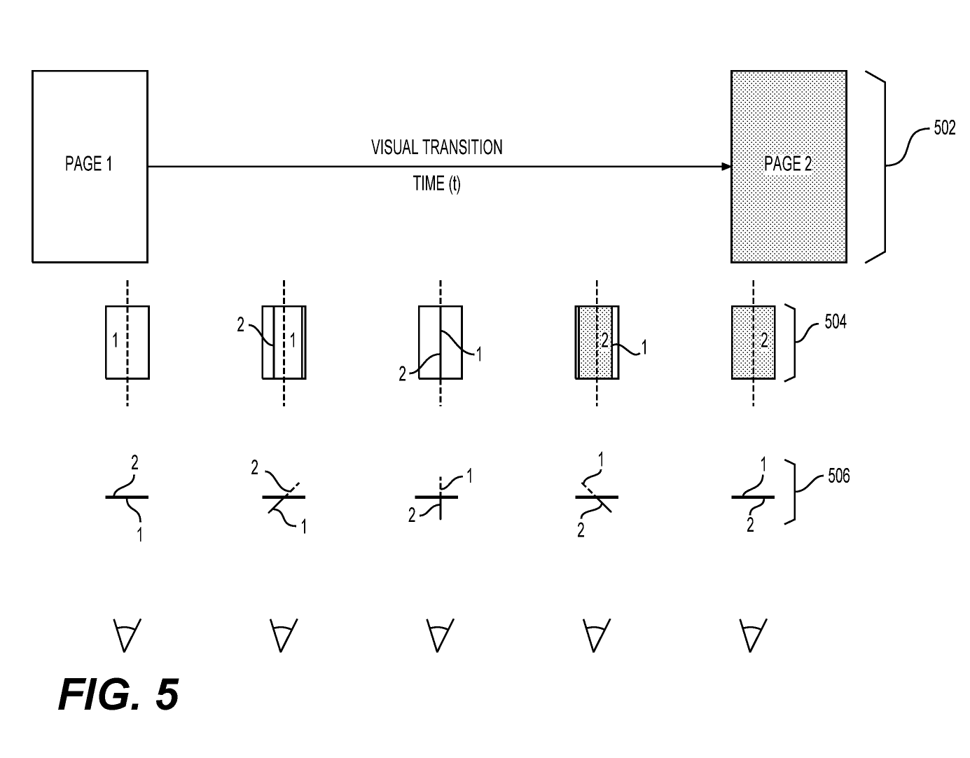

Turning now to FIG. 5, there is shown a diagram illustrating a first visual transition in accordance with an embodiment of the present technology. A content element 502 is illustrated while transitioning from a first displayable page to a second displayable page. The content element 502 may be part of a content stream comprising one or more content elements. In some embodiments, two content elements may be sufficient to define a content stream. The content element 502 may be similar to the content elements 302, 304, 306. In the embodiments illustrated at FIG. 5, the content element 502 comprises the first displayable page and the second displayable page. The first displayable page comprises one or more media assets and the second displayable page comprises items allowing an action to be executed in connection with the content element. The action may be associated with providing feedback in association with information contained in the first displayable page. The first displayable page defines a front side of the content element 502. The second displayable page defines a first back side of the content element 502.

The first visual transition comprises a first rotation from the first displayable page to the second displayable page, the first rotation being about an axis. In some embodiments, the axis extends in a direction (also referred in the present document as a “second direction”) aligned with the scrolling direction of the content stream. In some embodiments, the axis bisects the first displayable page in a first portion and a second portion. In some embodiments, the first rotation is along a first rotational direction along the axis. When viewed from the top, the first rotational direction may be qualified as being in an anticlockwise direction. However, in some alternative embodiments, the first rotational direction may be in a clockwise direction.

In some embodiments, the first visual transition is caused, by a processing unit of the electronic device 210. The electronic device 210 may cause the display of the first visual transition by generating and/or rendering transitional visual representations of the first displayable page and of the second displayable page so as to display, on the screen, a continuous rotation movement to the user. A set of diagrams 504 illustrate an embodiment of a visual transition over time (t) taken from a point of view of a user holding the electronic device 210 vertically. A set of diagrams 506 illustrate the embodiment of the visual transition over time (t) taken from a virtual point of view located on top of the electronic device 210. In the set of diagrams 504 and in the set of diagrams 506, reference numbers “1” represent the first displayable page and the reference numbers “2” represent the second displayable page. As a person skilled in the art of the present technology may appreciate, an amount of time t required to complete the first visual transition may greatly vary, from a few milliseconds to multiple seconds, and may depend from many factors. Such factors may include a desire to have the user 170 perceive that the first visual transition happens quickly or slowly. Such factors may also include a technical performance of the hardware of the electronic device 210 which will be processing and rendering the first visual transition. In addition, even though the first visual transition of FIG. 5 is illustrated as comprising three intermediate stages to complete a transition from the first displayable page to the second displayable page, it should not be construed as being limitative. The first visual transition may include more or less intermediate stages without departing from the scope of the present technology.

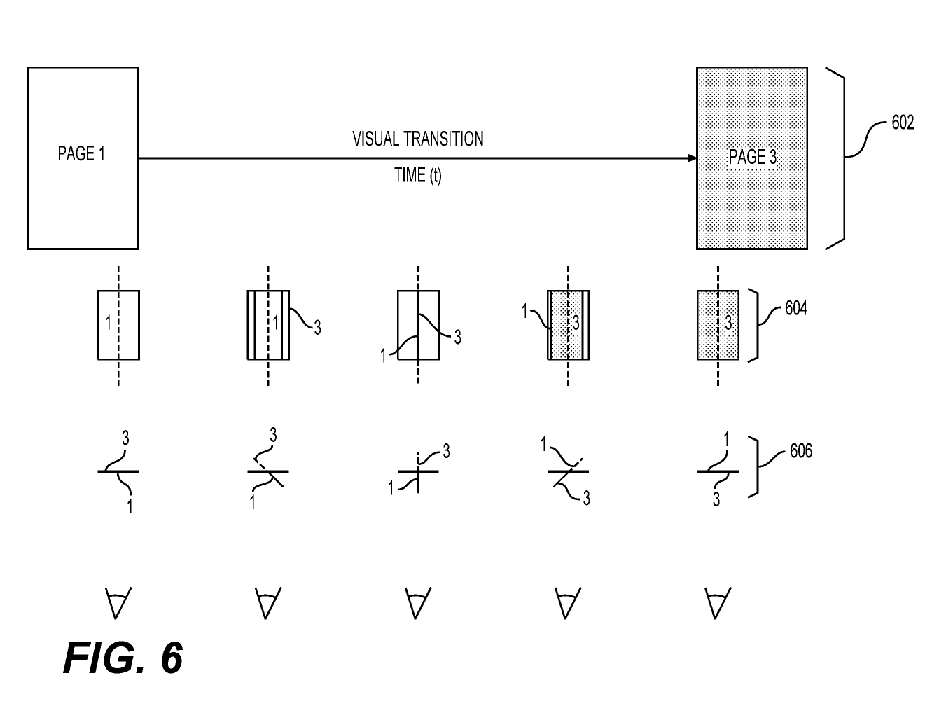

Turning now to FIG. 6, there is shown a diagram illustrating a second visual transition in accordance with an embodiment of the present technology. A content element 602 is illustrated while transitioning from a first displayable page to a third displayable page. The content element 602 may be part of a content stream comprising one or more content elements. In some embodiments, two content elements may be sufficient to define a content stream. The content element 602 may be similar to the content elements 302, 304, 306, 502. In the embodiments illustrated at FIG. 6, the content element 602 comprises the first displayable page and the third displayable page. The first displayable page comprises one or more media assets and the third displayable page comprises an action to be executed in connection with the content element. The action may be associated with providing feedback in association with information contained in the first displayable page. In some embodiments, the action may be a removal of the content element from the content stream as it will be detailed in the paragraphs below. The first displayable page defines a front side of the content element 602. The third displayable page defines a second back side of the content element 602. In some embodiments, the third displayable page may be in replacement of the second displayable page. In some other embodiments, the third displayable page may be in addition to the second displayable page. In such embodiments, the content element comprises (i) a first displayable page defining a front side of the content element; (ii) a second displayable page defining a first back side of the content element; and (iii) a third displayable page defining a second back side. As a result, the present technology may allow creating a representation that allows visually associating a page with two different back sides.

The second visual transition comprises a second rotation from the first displayable page to the third displayable page, the second rotation being about an axis. In some embodiments, the axis extends in a direction (also referred in the present document as a “second direction”) aligned with the scrolling direction of the content stream. In some embodiments, the axis bisects the first displayable page in a first portion and a second portion. In some embodiments, the axis is a same axis than the one relied upon to conduct the first visual transition. In some embodiments, the axis a different axis that the one relied upon to conduct the first visual transition. In some embodiments, the first rotation is along a first rotational direction along the axis. When viewed from the top, the first rotational direction may be qualified as being in a clockwise direction. However, in some alternative embodiments, the first rotational direction may be in an anticlockwise direction.

In some embodiments, as for the first visual transition, the second visual transition is caused, by a processing unit of the electronic device 210. The electronic device 210 may cause the display of the second visual transition by generating transitional visual representations of the first displayable page and of the third displayable page so as to display, on the screen, a continuous rotation movement to the user. A set of diagrams 604 illustrates an embodiment of a visual transition over time (t) taken from a point of view of a user holding the electronic device 210 vertically. A set of diagrams 606 illustrates the embodiment of the visual transition over time (t) taken from a virtual point of view located on top of the electronic device 210. In the set of diagrams 604 and in the set of diagrams 606, reference numbers “1” represent the first displayable page and the reference numbers “3” represent the third displayable page. As a person skilled in the art of the present technology may appreciate, an amount of time t required to complete the first visual transition may greatly vary, from a few milliseconds to multiple seconds, and may depend from many factors. Such factors may include a desire to have the user 170 perceive that the first visual transition happens quickly or slowly. Such factors may also include a technical performance of the hardware of the electronic device 210 which will be processing and rendering the first visual transition. In addition, even though the second visual transition of FIG. 6 is illustrated as comprising three intermediate stages to complete a transition from the first displayable page to the third displayable page, it should not be construed as being limitative. The second visual transition may include more or less intermediate stages without departing from the scope of the present technology.

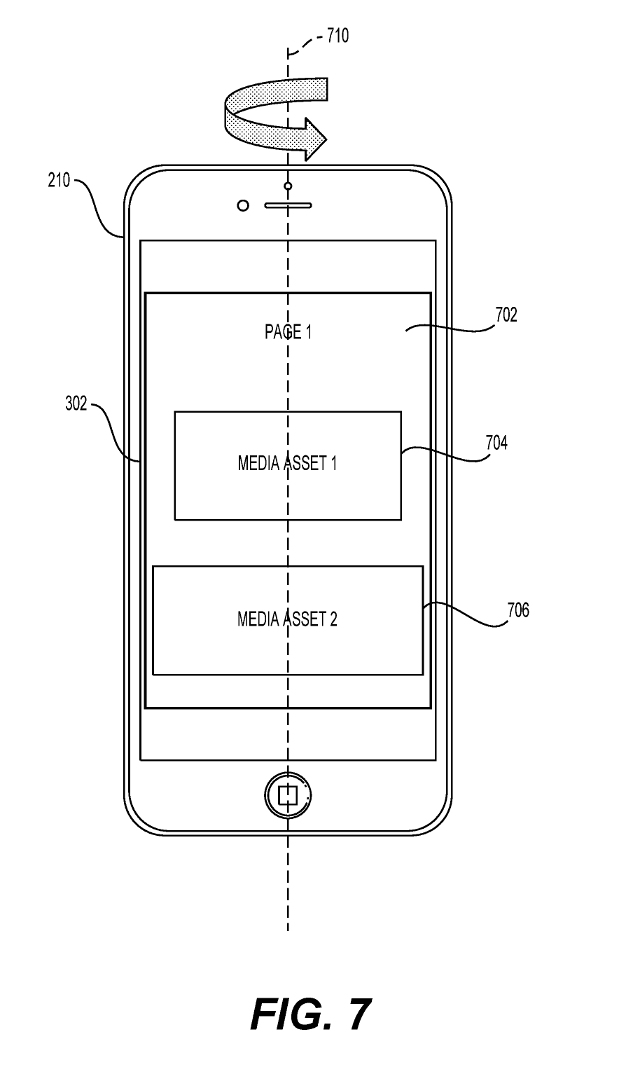

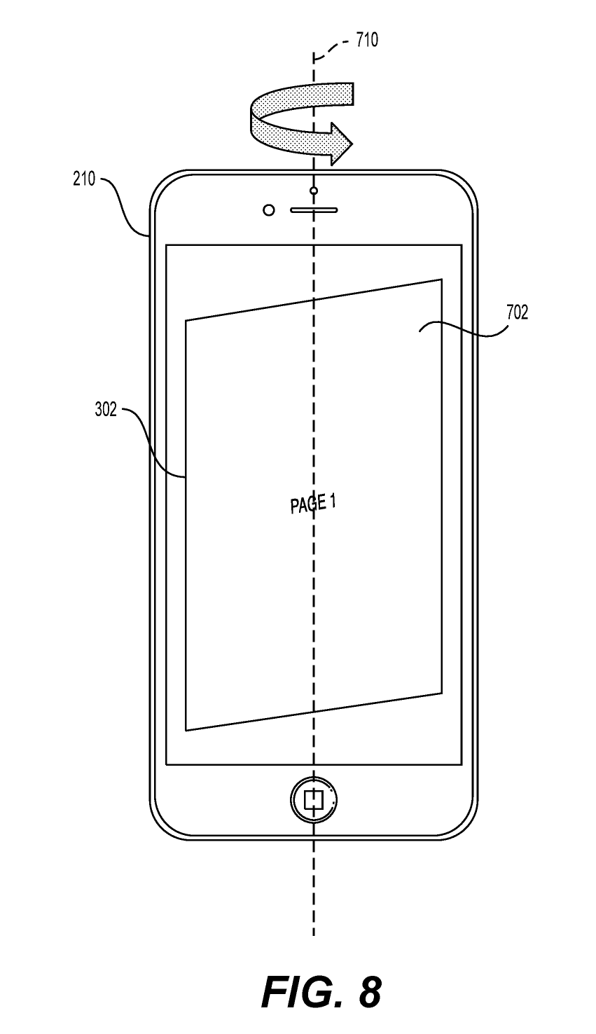

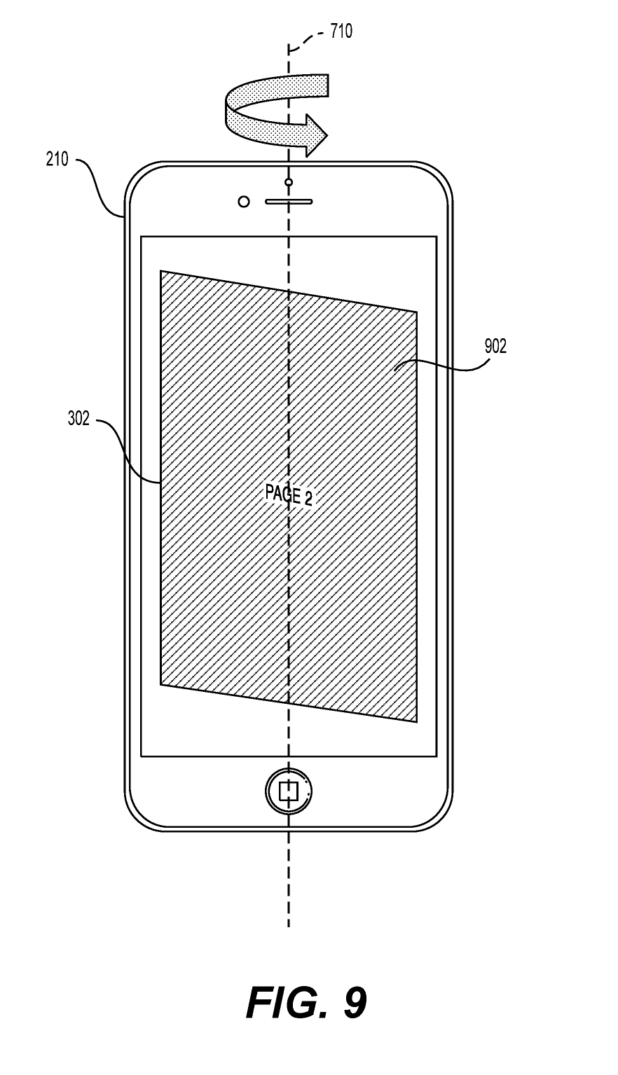

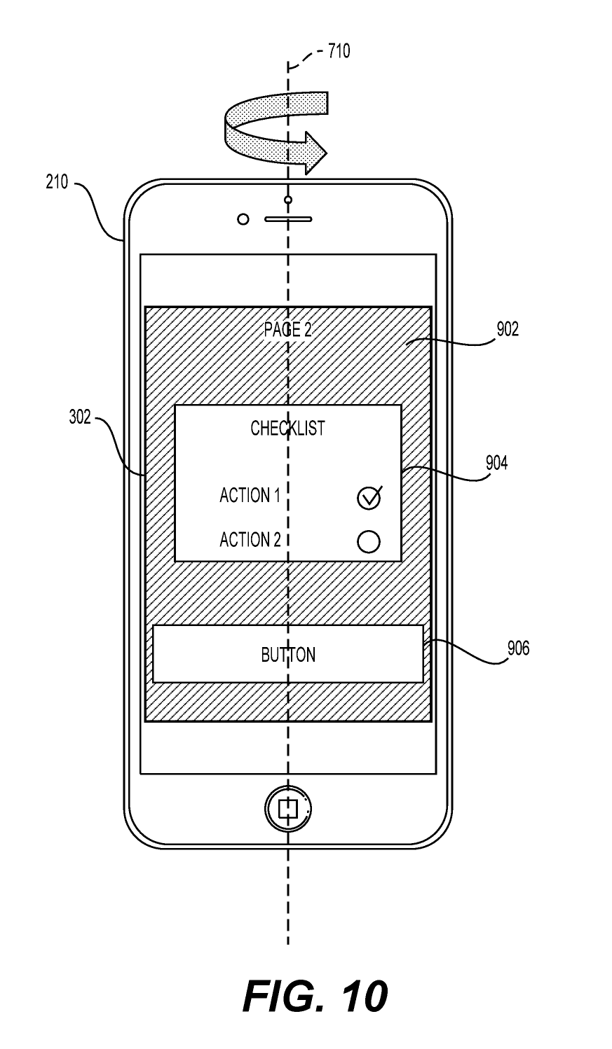

Turning now to FIG. 7-10, there is shown snapshots taken during the first visual transition in accordance with an embodiment of the present technology. FIG. 7 illustrates the content element 302 displayed on the electronic device 210. The content element 302 comprises a first displayable page 702. The first displayable page 702 comprises a first media asset 704 and a second media asset 706. For example, but without being limitative, the first media asset 704 may be a picture and the second media asset 706 may be text of an article relating to the picture. In response to a first gesture input from the user 170, the first visual transition is initiated about an axis 710 in an anticlockwise direction. FIGS. 8 and 9 illustrates intermediate stages leading to a display of a second displayable page 902. FIG. 10 illustrates the second displayable page 902. The second displayable page 902 comprises a checklist 904 and a button 906. The checklist 904 and/or the button 906 allow the user to provide feedback in connection with information presented at the first displayable page 702. Such feedback may include, for example, but without being limitative, “like” or “do not like”. The checklist 904 and/or the button 906 allow the user to initiate an action in connection with the first displayable page 702 and/or the content element 302. Such action may be a removal of the content element from the content stream. As a person skilled in the art of the present technology may appreciate, such approach allows the user 170 to interact with the content element 302 by placing a gesture input which will initiate a first visual transition and/or a second visual transition while limiting a number of interactions with the electronic device 210 that could have been otherwise required if other approaches were used. The limited number of interactions may therefore result in (1) reducing a number of gestures a user has to physically conduct with the electronic device 210; (2) reducing disruption of a navigation experience of the user 170 while interacting with the content stream; and/or (3) more intuitive interaction of the user 170 with the content stream through the electronic device 210.

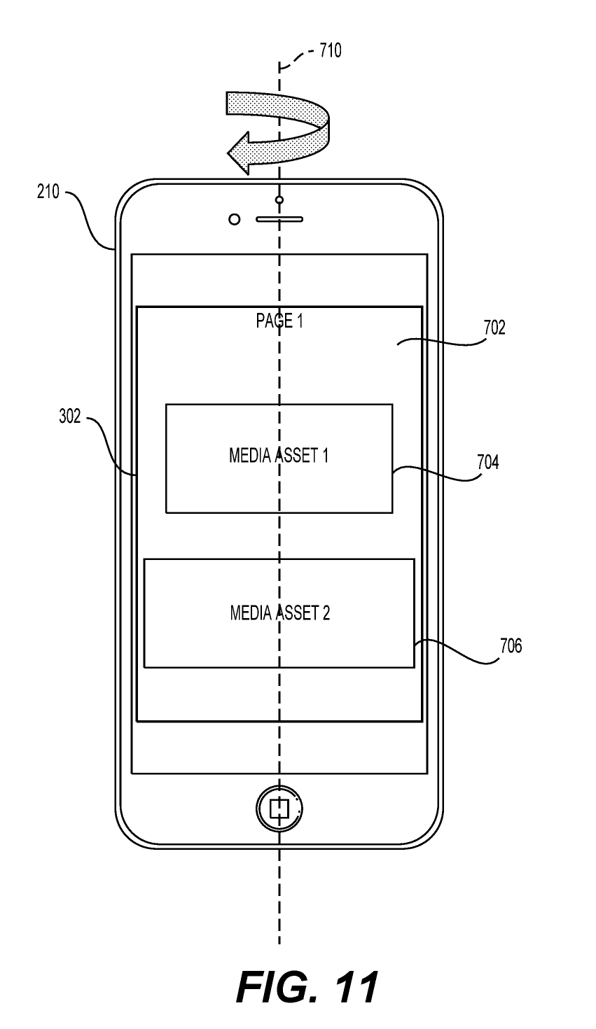

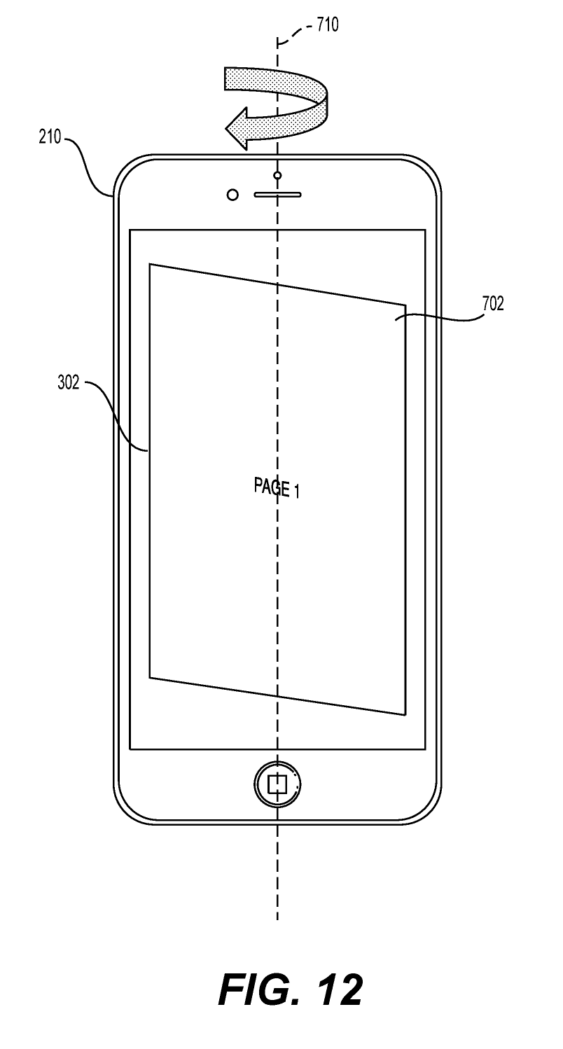

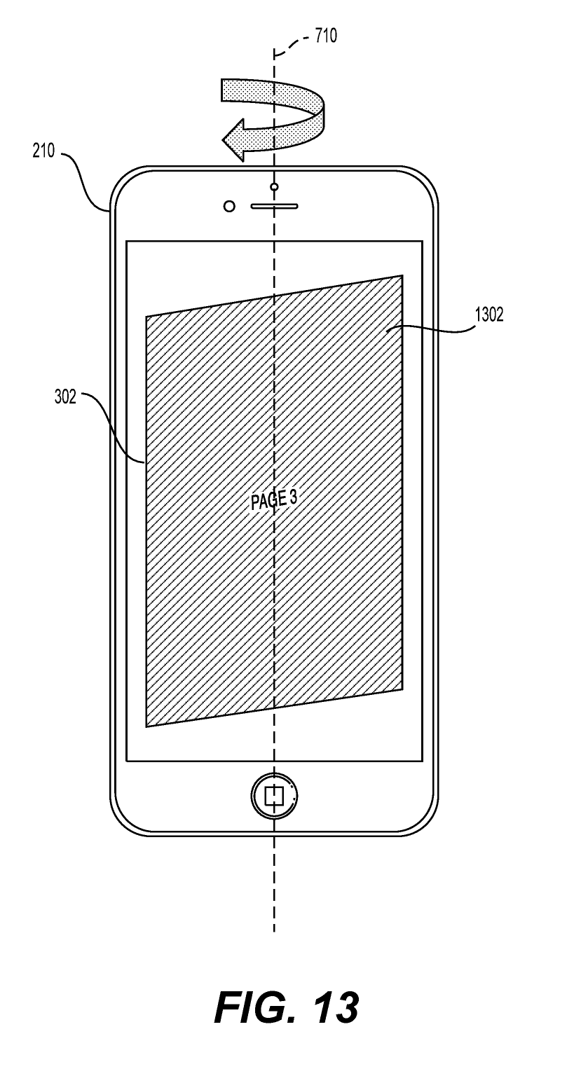

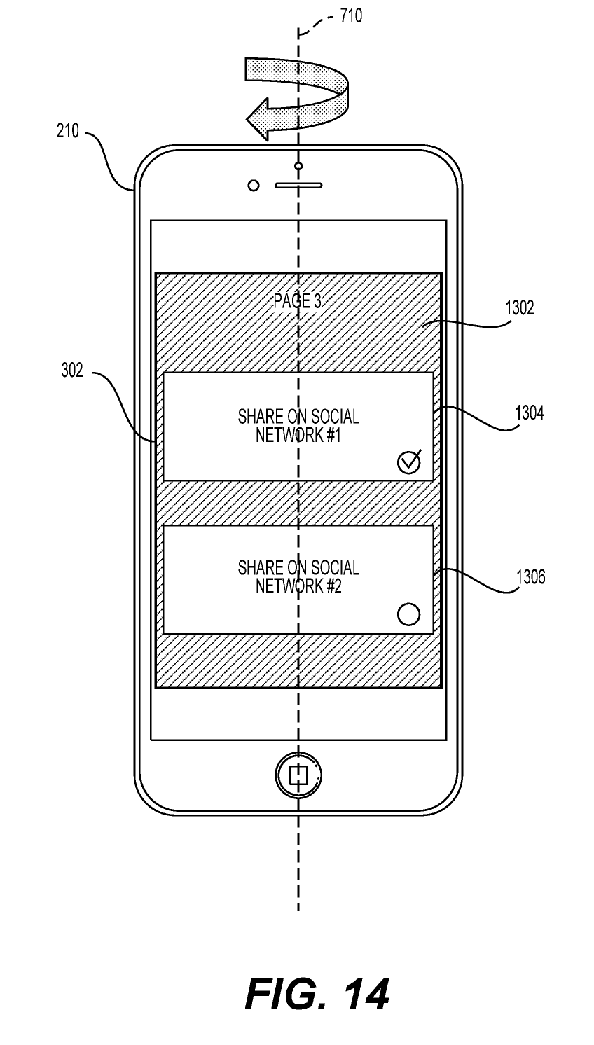

Turning now to FIG. 11-14, there is shown snapshots taken during the second visual transition in accordance with an embodiment of the present technology. FIG. 11 illustrates the content element 302 displayed on the electronic device 210. The content element 302 comprises the first displayable page 702. The first displayable page 702 comprises the first media asset 704 and the second media asset 706. In response to a second gesture input from the user 170, the second visual transition is initiated about the axis 710 in a clockwise direction. FIGS. 12 and 13 illustrates intermediate stages leading to a display of a third displayable page 1302. FIG. 14 illustrates the third displayable page 1302. The third displayable page 1302 comprises a first action button 1304 and a second action button 1306. The first action button 1304 and the second action button allow the user to provide initiate an action in connection with the first displayable page 702 and/or the content element 302. Such action may be a sharing of the content element 302 and/or information associated with the content element 302 or the first displayable page 702 on one or more social networks.

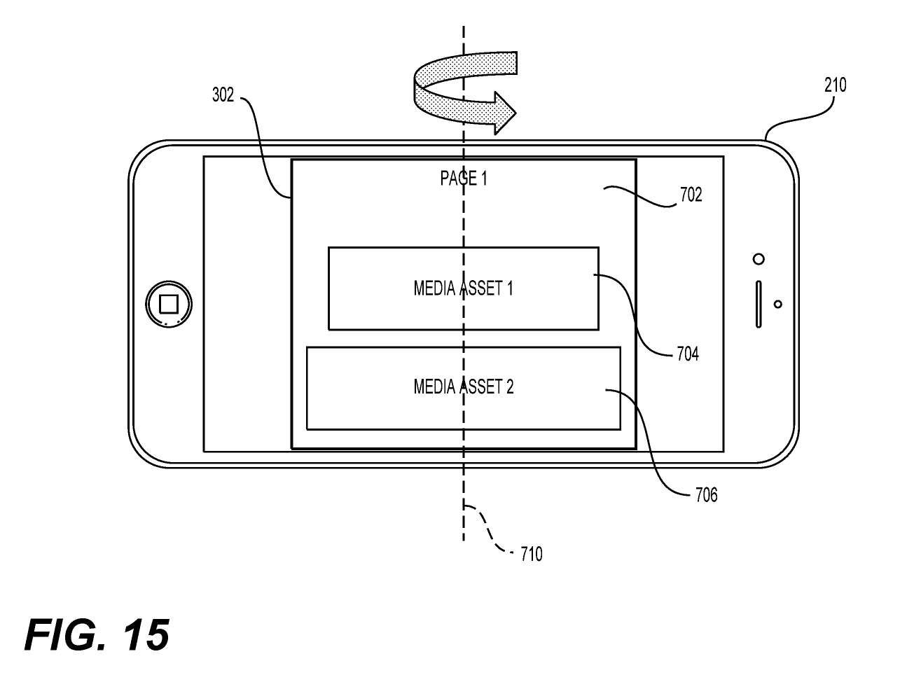

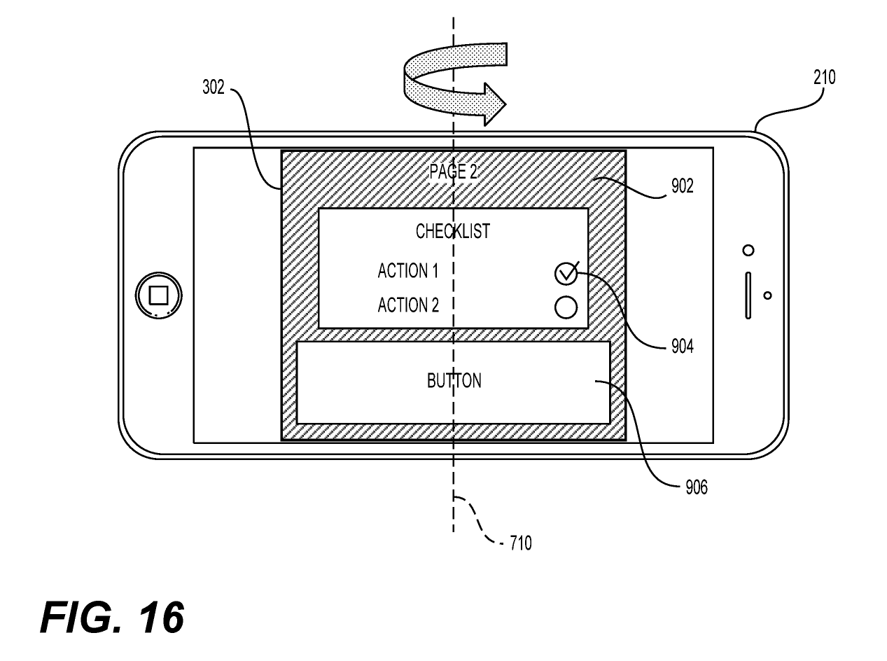

FIGS. 15 and 16 illustrates an alternative embodiment of the first visual transition be completed on the electronic device 210 when the content stream is oriented so as be scrolled in a horizontal direction.

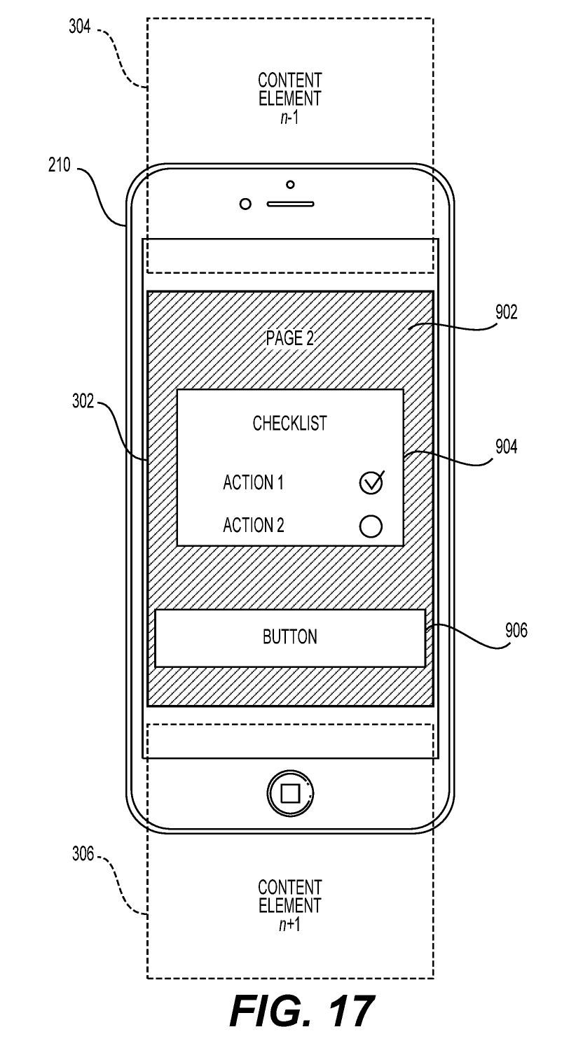

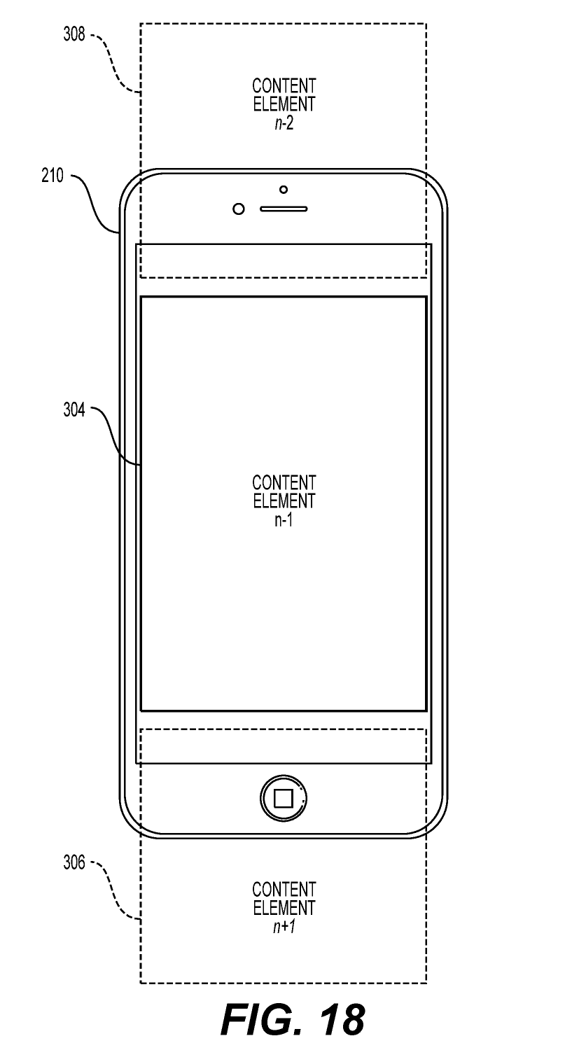

FIGS. 17 and 18 illustrates an embodiment of a removal of a content element from a content stream. In particular, FIG. 17 illustrates the content element 302, and more particularly the second displayable page 902 of the content element 302. For the purpose of exemplifying the sequence of events, it is assumed that an action 1 of the checklist 904 is associated with an action of a removal of the content element 302 from the content stream. The user 170, which may have access the second displayable page 902 by inputting a first gesture input, selects the action 1 (for example, by physically clicking on the area of the screen 190 representing the circle associated with the action 1). The electronic device 210, upon determining that the action 1 has been commanded by the user 170, proceeds to the removal of the content element 302 from the content stream. The result of this action is illustrated at FIG. 18 where an updated content stream is illustrated. The updated content stream now comprises the content element 304 being the current content element and a previous content element 308.

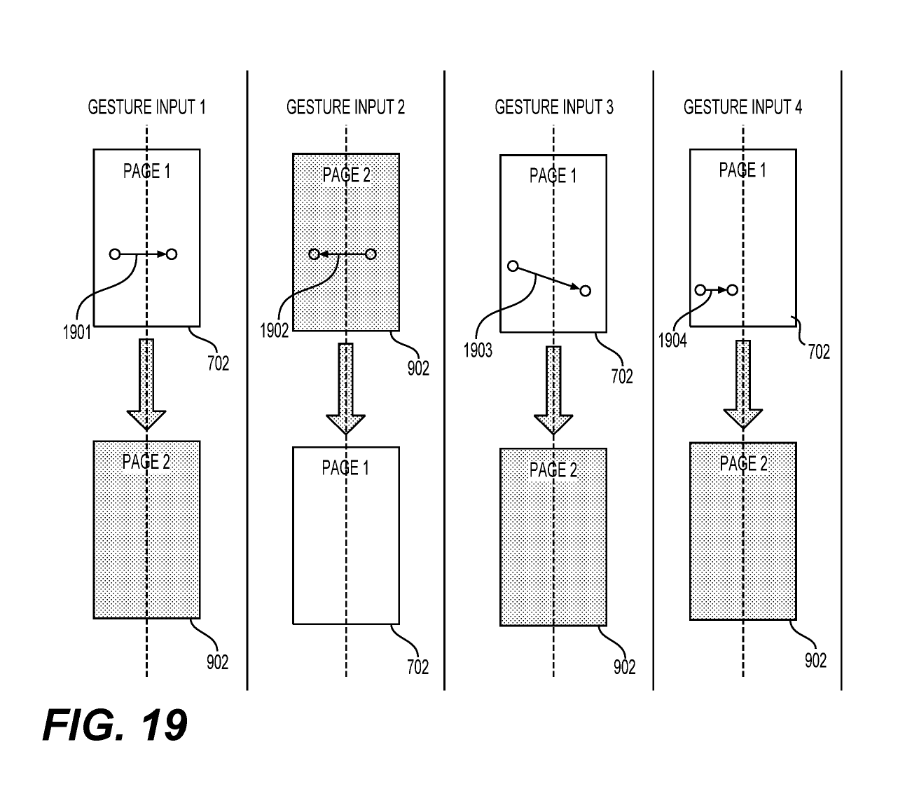

Turning now to FIG. 19, there are shown examples of gestures defining various inputs in accordance with embodiments of the present technology. More specifically, four examples of gesture inputs are illustrated. These gesture inputs may be relied upon to define a first gesture input, in accordance with some embodiments of the present technology. The first example “Gesture Input 1” illustrates a first gesture 1901 intended to cause the first visual transition to transition from the display of the first displayable page 702 to the display of the second displayable page 902. The first gesture 1901 may be conducted on the screen 190 of the electronic device 210. The first gesture 1901 may be, in some embodiments, conducted on other interfaces of the electronic device 210 such as, but not limited to, on a trackpad associated with the electronic device 210. In some embodiments, the first gesture 1901 is a gesture input via the touch hardware (e.g., the touch hardware of the screen 190). The first gesture 1901 is along a first direction perpendicular to a scrolling direction of the content stream illustrated by an axis bisecting the first displayable page 702 and the second displayable page 902. The first gesture 1901 is a swipe gesture comprising a touchdown event, a drag event and a liftoff event. The swipe gesture goes from a left side of the screen 190 to a right side of the screen 190.

The second example “Gesture Input 2” illustrates a second gesture 1902 intended to cause the second visual transition to transition from the display of the second displayable page 902 to the display of the first displayable page 702. The second gesture 1902 may be conducted on the screen 190 of the electronic device 210. The second gesture 1902 is along the first direction perpendicular to the scrolling direction of the content stream illustrated by the axis bisecting the first displayable page 702 and the second displayable page 902. The second gesture 1902 is a swipe gesture comprising a touchdown event, a drag event and a liftoff event. The swipe gesture goes from a right side of the screen 190 to a left side of the screen 190.

The third example “Gesture Input 3” illustrates a third gesture 1903 intended to cause the first visual transition to transition the display of the first displayable page 702 to the display of the second displayable page 902. The third gesture 1903 is a variant of the first gesture 1901 wherein the third gesture 1903 is not along the first direction perpendicular to the scrolling direction but rather along a direction which is at an angle with respect to the scrolling direction. As the person skilled in the art of the present technology may appreciate, this embodiment is more likely to reflect a gesture input in real life. It should be understood that a direction of the gesture and/or the angle defined by the direction and the scrolling direction should not be construed as being limitative. A wide number of variations may be envisioned without departing from the scope of the present technology and, as result, the use of “perpendicular” throughout the present document should be not be constructed strictly.

The fourth example “Gesture Input 4” illustrates a fourth gesture 1904 intended to cause the first visual transition to transition from the display of the first displayable page 702 to the display of the second displayable page 902. As the first gesture 1901, the fourth gesture 1904 is a swipe gesture comprising a touchdown event, a drag event and a liftoff event. The fourth gesture 1904 is a variant of the first gesture 1901 wherein events defining the fourth gesture 1904 (namely the touchdown event, the drag event and the liftoff event) are completed without having to cross the axis bisecting the first displayable page 702 and the second displayable page 902.

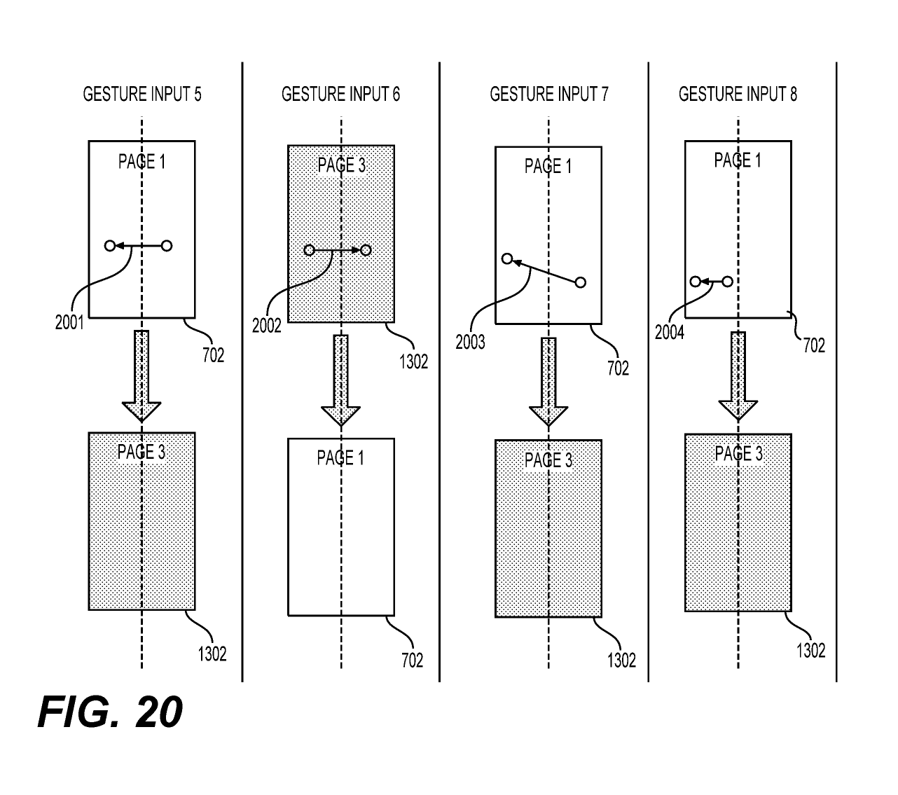

Turning now to FIG. 20, there are shown examples of gestures defining various inputs in accordance with embodiments of the present technology. More specifically, four examples of gesture inputs are illustrated. These gesture inputs may be relied upon to define a second gesture input, in accordance with some embodiments of the present technology. The fifth example “Gesture Input 5” illustrates a fifth gesture 2001 intended to cause the second visual transition to transition from the display of the first displayable page 702 to the display of the third displayable page 1302. The fifth gesture 2001 may be conducted on the screen 190 of the electronic device 210. The fifth gesture 2001 may be, in some embodiments, conducted on other interfaces of the electronic device 210 such as, but not limited to, on a trackpad associated with the electronic device 210. In some embodiments, the fifth gesture 2001 is a gesture input via the touch hardware (e.g., the touch hard ware of the screen 190). The fifth gesture 2001 is along a first direction perpendicular to a scrolling direction of the content stream illustrated by an axis bisecting the first displayable page 702 and the third displayable page 1302. The fifth gesture 2001 is a swipe gesture comprising a touchdown event, a drag event and a liftoff event. The swipe gesture goes from a right side of the screen 190 to a left side of the screen 190.

The sixth example “Gesture Input 6” illustrates a sixth gesture 2002 intended to cause the second visual transition to transition from the display of the third displayable page 1302 to the display of the first displayable page 702. The sixth gesture 2002 may be conducted on the screen 190 of the electronic device 210. The sixth gesture 2002 is along the first direction perpendicular to the scrolling direction of the content stream illustrated by the axis bisecting the first displayable page 702 and the third displayable page 1302. The sixth gesture 2002 is a swipe gesture comprising a touchdown event, a drag event and a liftoff event. The swipe gesture goes from a left side of the screen 190 to a right side of the screen 190.

The seventh example “Gesture Input 7” illustrates a seventh gesture 2003 intended to cause the second visual transition to transition the display of the first displayable page 702 to the display of the third displayable page 1302. The seventh gesture 2003 is a variant of the fifth gesture 2001 wherein the seventh gesture 2003 is not along the first direction perpendicular to the scrolling direction but rather along a direction which is at an angle with respect to the scrolling direction. As the person skilled in the art of the present technology may appreciate, this embodiment is more likely to reflect a gesture input in real life. It should be understood that a direction of the gesture and/or the angle defined by the direction and the scrolling direction should not be construed as being limitative. A wide number of variations may be envisioned without departing from the scope of the present technology and, as result, the use of “perpendicular” throughout the present document should be not be constructed strictly.

The eighth example “Gesture Input 8” illustrates an eighth gesture 2004 intended to cause the second visual transition to transition from the display of the first displayable page 702 to the display of the third displayable page 1302. As the fifth gesture 2001, the eighth gesture 2004 is a swipe gesture comprising a touchdown event, a drag event and a liftoff event. The eighth gesture 2004 is a variant of the fifth gesture 2001 wherein events defining the eighth gesture 2004 (namely the touchdown event, the drag event and the liftoff event) are completed without having to cross the axis bisecting the first displayable page 702 and the third displayable page 1302.

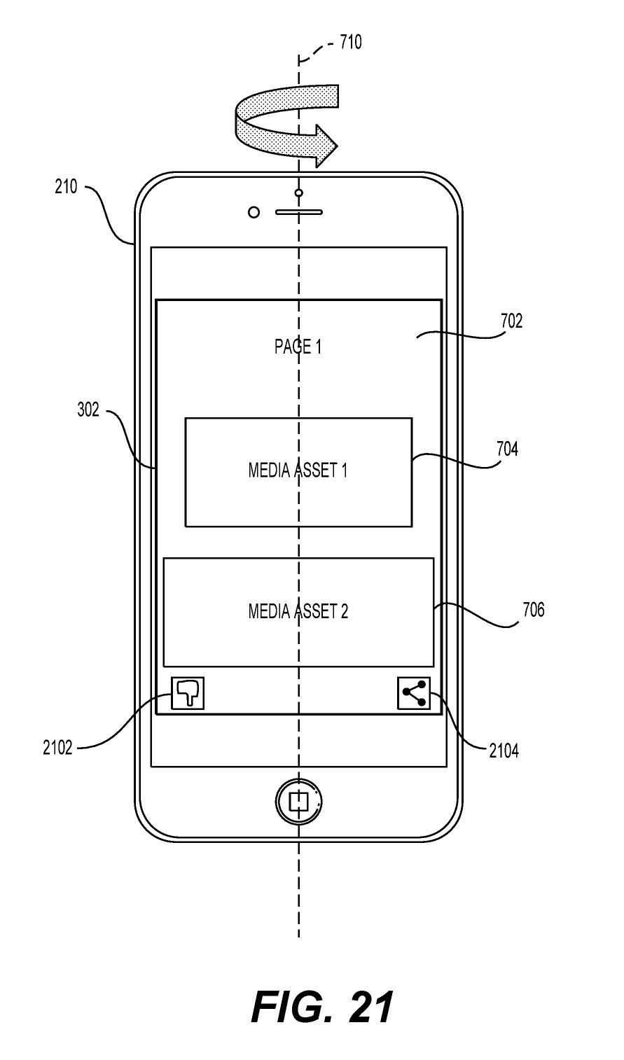

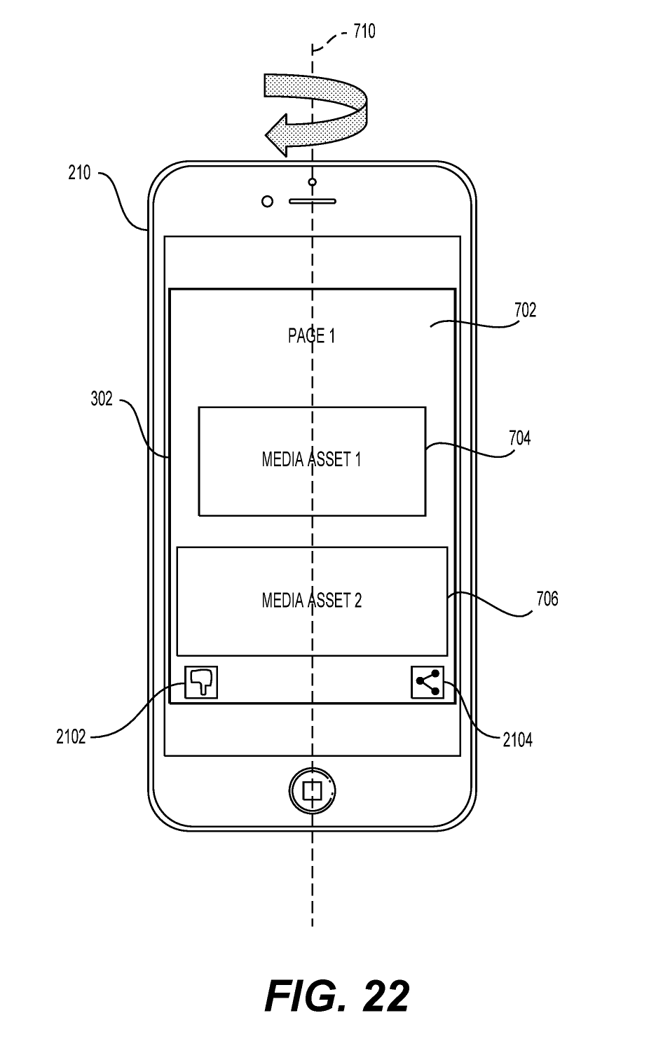

Turning now to FIG. 21 and FIG. 22, there is shown an alternative approach for a user to provide inputs in accordance with embodiments of the present technology. The content element 302 of FIG. 21 comprises the first displayable page 702. The first displayable page 702 comprises the first media asset 704 and the second media asset 706. The first displayable page 702 also comprises a first graphical user interface (GUI) component 2102 and a second GUI component 2104. The first GUI component 2102 and the second GUI component 2104 may take multiple forms, including a surface including an icon (as it is the case in the embodiment illustrated at FIG. 21). Other variations may also be envisioned. In some embodiments, the second GUI component 2104 is displayed on a portion of the screen 190 so that a first interaction of the user 170 (for example by a touching event on the surface including the icon or a click) with the second GUI component 2104 initiates the first visual transition resulting in the second displayable page 902 being displayed. In some embodiments, the second GUI component 2104 is located outward of the axis 710 so that a gesture of the user 170 on the second GUI component 2104 causes to reproduce a physical reaction of rotational motion of the first displayable page 702. Such rotational motion may give a visual impression to the user 170 that the second GUI component 2104 is being pushed and that the first GUI component 2102 is being lifted up. The second GUI component 2104 may be used in addition to or in replacement of a gesture input (such as the gesture inputs depicted in connection with FIG. 19). In other words, in accordance with the embodiment of FIG. 21, the user 170 may press on the second GUI component 2104 instead of conducting a swipe gesture on the screen 190 to cause the first visual transition to be initiated. Other variations are also possible and may become apparent to a person skilled in the art of the present technology.

The content element 302 of FIG. 22 comprises the first displayable page 702. The first displayable page 702 comprises the first media asset 704 and the second media asset 706. The first displayable page 702 also comprises the first GUI component 2102 and the second GUI component 2104. In some embodiments, the first GUI component 2102 is displayed on a portion of the screen 190 so that a second interaction of the user 170 (for example by a touching event on the surface including the icon or a click) with the first GUI component 2102 initiates the second visual transition resulting in the third displayable page 1302 being displayed. In some embodiments, the first GUI component 2102 is located outward of the axis 710 so that a gesture of the user 170 on the first GUI component 2102 causes to reproduce a physical reaction of rotational motion of the first displayable page 702. Such rotational motion may give a visual impression to the user 170 that the first GUI component 2102 is being pushed and that the second GUI component 2104 is being lifted up. The first GUI component 2102 may be used in addition to or in replacement of a gesture input (such as the gesture inputs depicted in connection with FIG. 20). In other words, in accordance with the embodiment of FIG. 22, the user 170 may press on the first GUI component 2102 instead of conducting a swipe gesture on the screen 190 to cause the second visual transition to be initiated. Other variations are also possible and may become apparent to a person skilled in the art of the present technology.

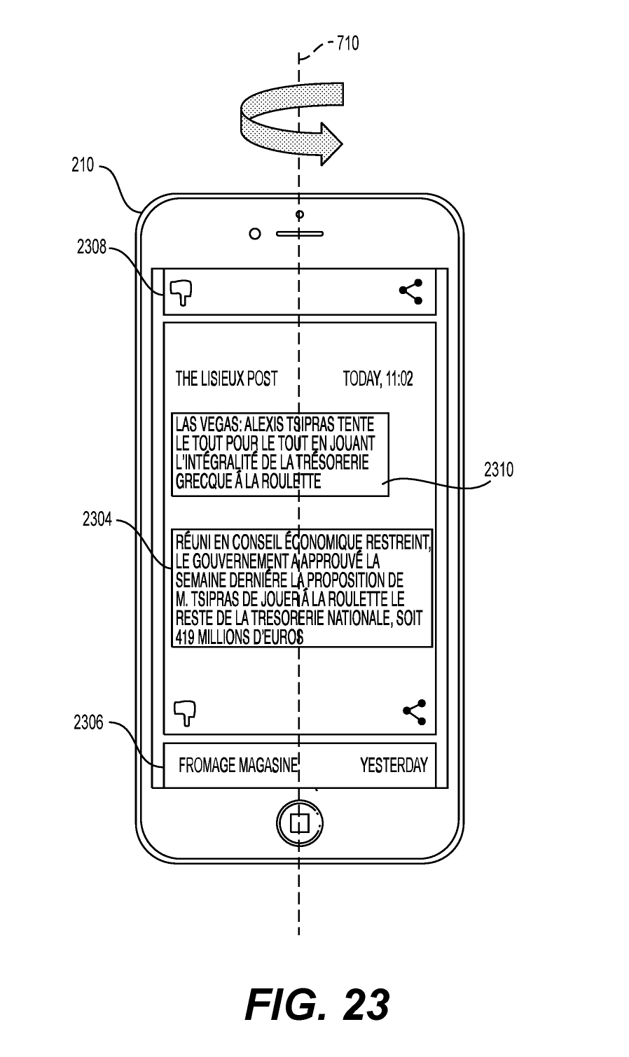

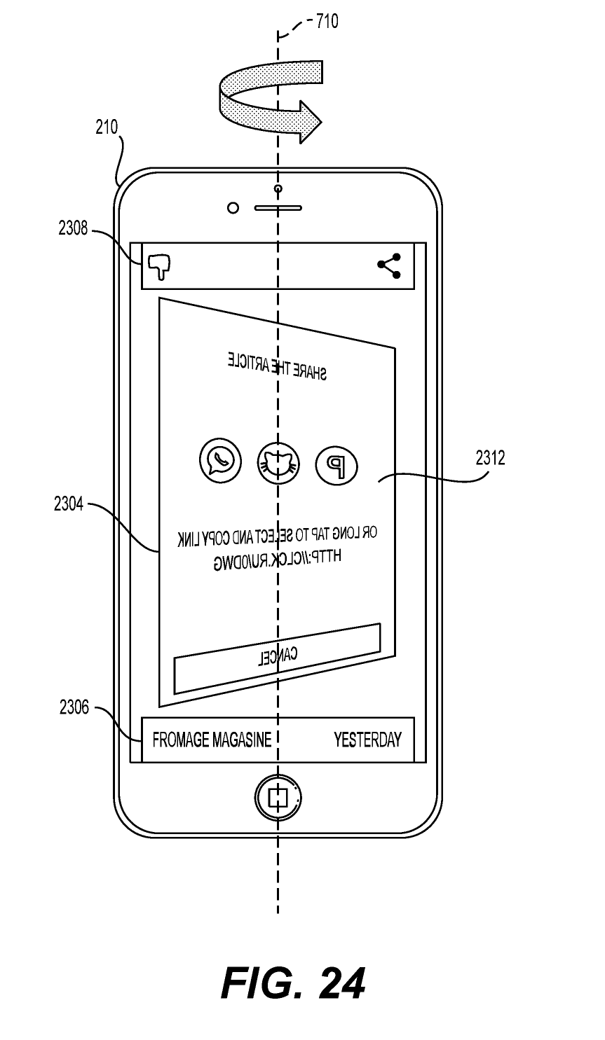

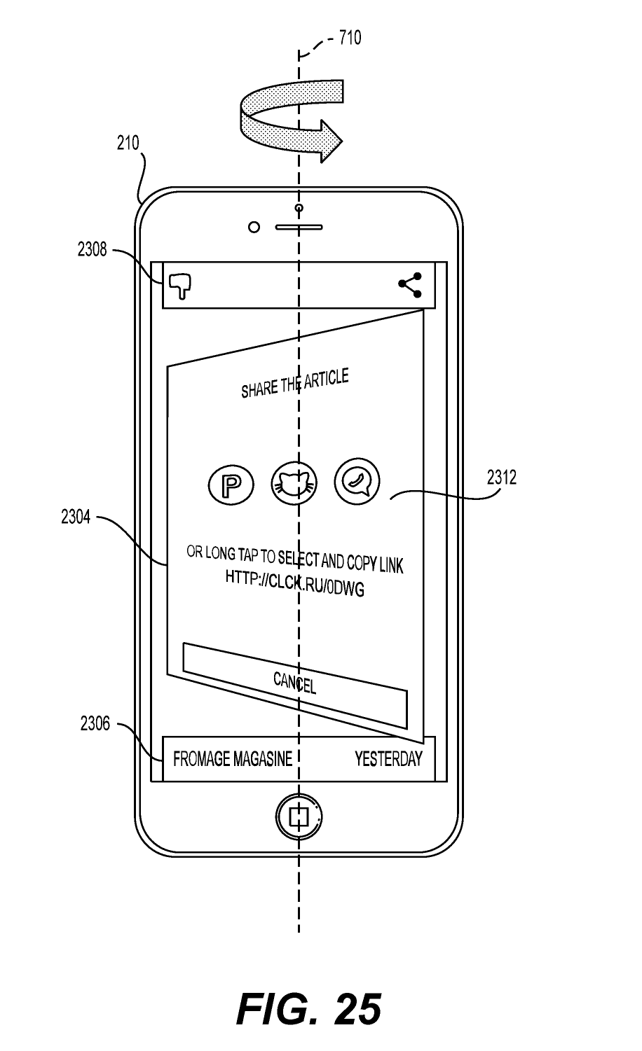

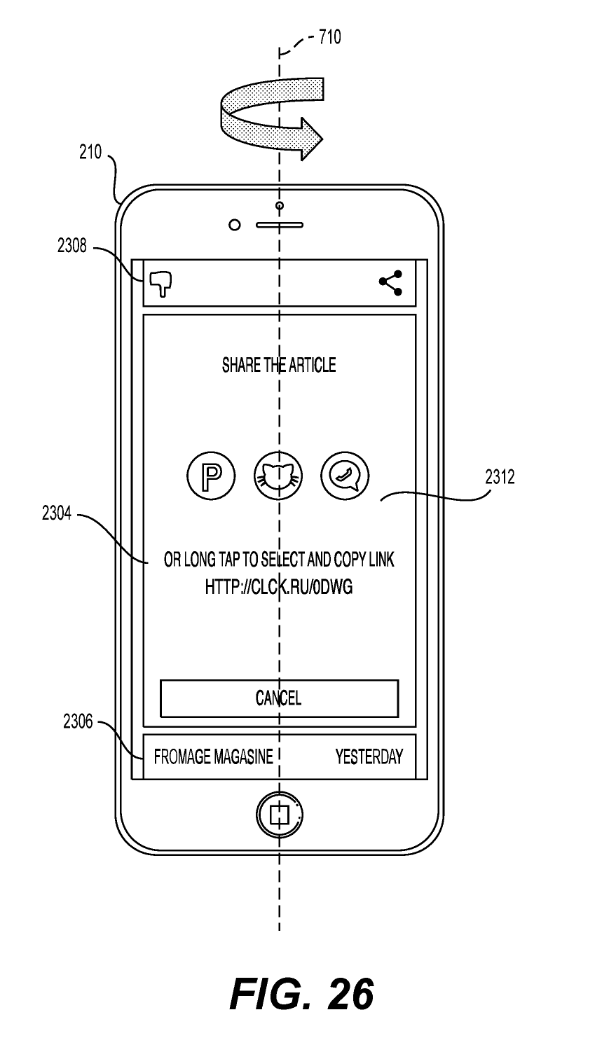

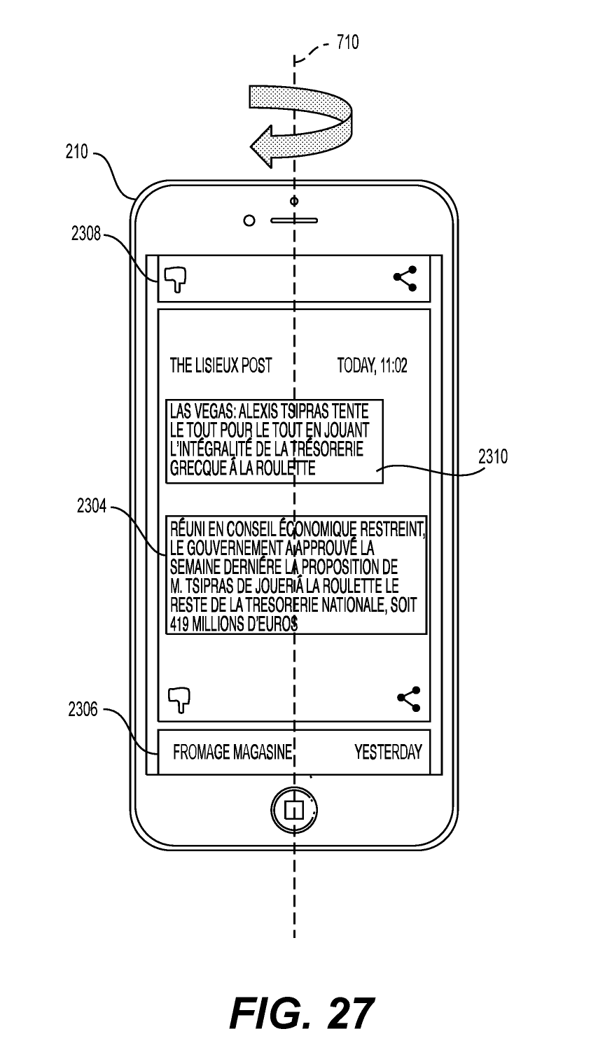

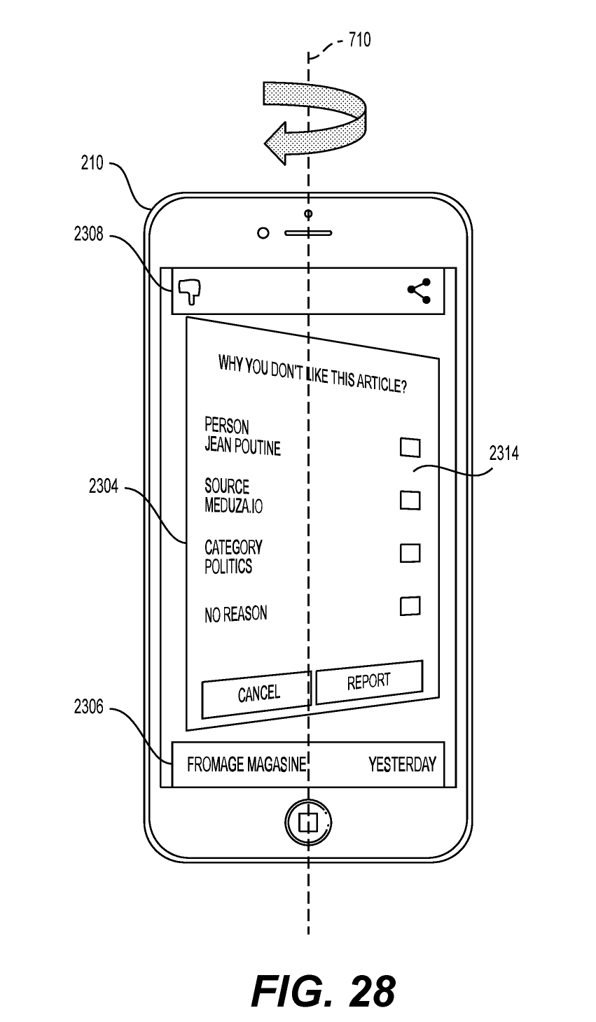

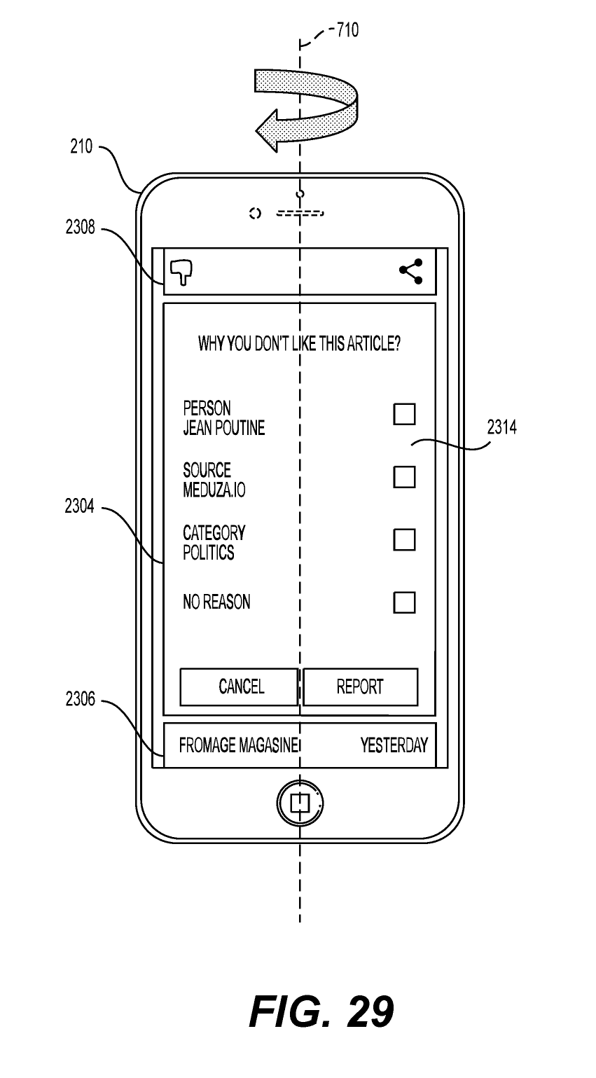

Turning now to FIG. 23 to FIG. 29, there is shown an example of implementation of at least some of the aspects described in connection with the various embodiments. FIG. 23 to FIG. 29 illustrates the electronic device 210 displaying a content element 2310 comprising a first displayable page 2304. The electronic device 210 also displays a portion of a content element 2308 and a portion of a content element 2306. FIG. 24 to FIG. 26 illustrate a first visual transition from the first displayable page 2304 to a second displayable page 2312. FIG. 27 to FIG. 29 illustrate a second visual transition from the first displayable page 2304 to a third displayable page 2314.

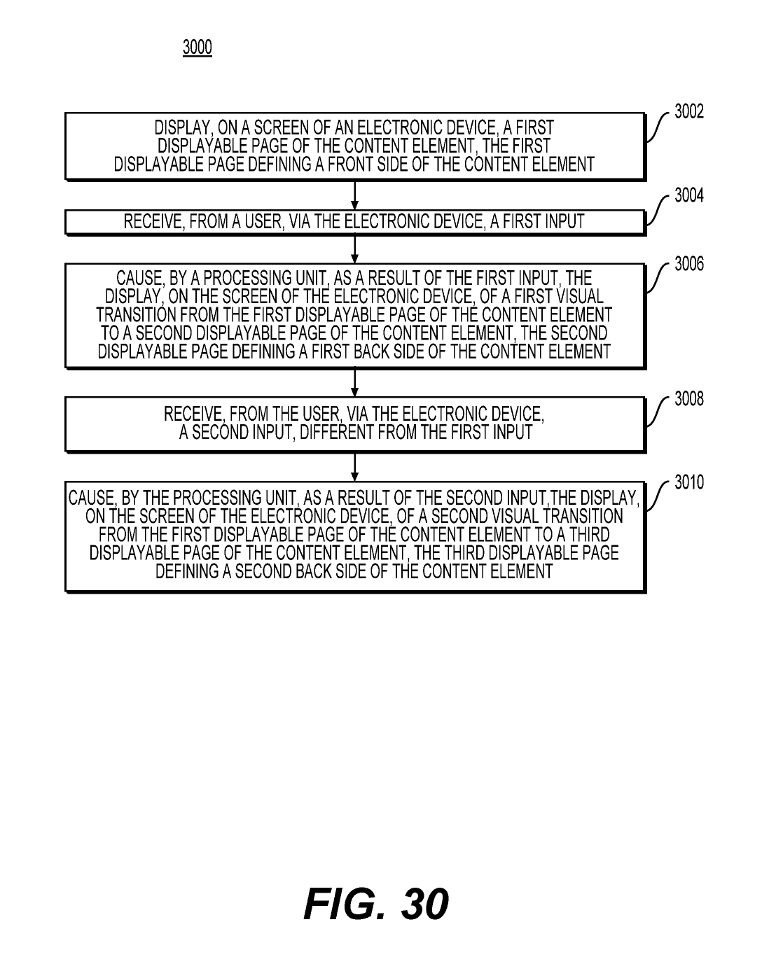

Having described, with reference to FIG. 1 to FIG. 29, some non-limiting example instances of systems and computer-implemented methods used in connection with the problem of interacting with a content element of a content stream, we shall now describe general solutions to the problem with reference to FIG. 30 to FIG. 32.

More specifically, FIG. 30 shows a flowchart illustrating a first computer-implemented method 3000 of interacting with a content element of a content stream. In some embodiments, the method 3000 may be (completely or partially) implemented on the computer system 100, the electronic device 210 and/or the server 222. As a person skilled in the art of the present technology may appreciate, some or all of the aspects and alternative embodiments recited in connection with the method 3000 may equally be applicable to or adaptable to the methods 3100 and 3200.

The method 3000 starts at a step 3002 by displaying, on a screen of an electronic device, a first displayable page of the content element, the first displayable page defining a front side of the content element.

Then, at a step 3004, the method 3000 may receive, from a user, via the electronic device, a first input.

At a step 3006, the method 3000 executes causing, by a processing unit, as a result of the first input, the display, on the screen of the electronic device, of a first visual transition from the first displayable page of the content element to a second displayable page of the content element, the second displayable page defining a first back side of the content element. In some embodiments, the first visual transition comprises a first rotation from the first displayable page to the second displayable page, the first rotation being about an axis extending in a second direction aligned with the scrolling direction of the content stream, the first rotation being along a first rotational direction along the axis.

At a step 3008, the method 3000 may receive, from a user, via the electronic device, a second input different from the first input.

Then, at a step 3010, the method 3000 executes causing, by the processing unit, as a result of the second input, the display, on the screen of the electronic device, of a second visual transition from the first displayable page of the content element to a third displayable page of the content element, the third displayable page defining a second back side of the content element. In some embodiments, the second visual transition comprising a second rotation from the first displayable page to the third displayable page, the second rotation being along a second rotational direction along the axis, the second rotational direction being opposite the first rotational direction.

In some embodiments of the method 3000, the first input is a first interaction with a first graphical user interface (GUI) component and the second input is a second interaction with a second GUI component, the first GUI component and the second GUI component being displayed on the screen of the electronic device. In some embodiments, the axis bisects the first displayable page in a first portion and a second portion. In some embodiments, the first GUI component is displayed on the first portion so that the first interaction on the first GUI component initiates the first visual transition thereby reproducing a physical reaction of rotational motion of the first displayable content being pushed on the first portion, the first visual transition including a lifting of the second portion. In some embodiments, the second GUI component is displayed on the second portion so that the second interaction on the second GUI component initiates the second visual transition thereby reproducing a physical reaction of rotational motion of the first displayable content being pushed on the second portion, the second visual transition including a lifting of the first portion.

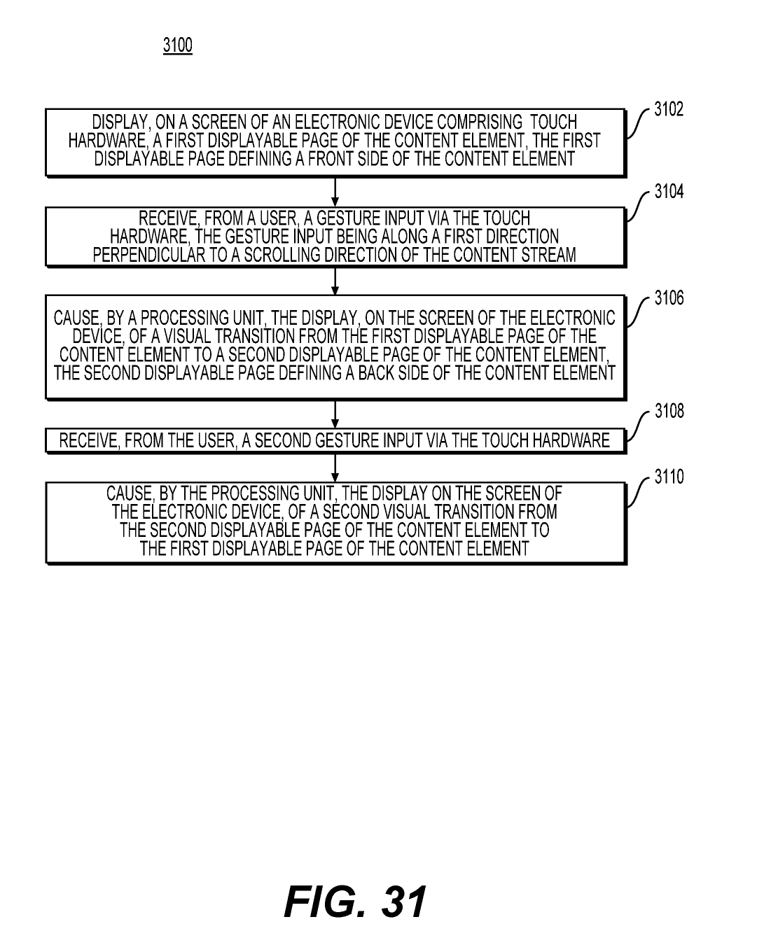

Turning now to FIG. 31, there is shown a flowchart illustrating a second computer-implemented method 3100 of interacting with a content element of a content stream. In some embodiments, the method 3100 may be (completely or partially) implemented on the computer system 100, the electronic device 210 and/or the server 222. As a person skilled in the art of the present technology may appreciate, some or all of the aspects and alternative embodiments recited in connection with the method 3100 may equally be applicable to or adaptable to the methods 3000 and 3200.

The method 3100 begins at a step 3102 by displaying, on a screen of an electronic device comprising touch hardware, a first displayable page of the content element, the first displayable page defining a front side of the content element.

Then, at a step 3104, the method 3100 may receive, from a user, a gesture input via the touch hardware, the gesture input being along a first direction perpendicular to a scrolling direction of the content stream. In some embodiments, the gesture input does not require to be “perfectly” along the first direction, some variations and/or irregularity in the gesture input may be deemed acceptable and may qualify as being a gesture input.

At a step 3106, the method 3100 executes causing, by a processing unit, the display, on the screen of the electronic device, of a visual transition from the first displayable page of the content element to a second displayable page of the content element, the second displayable page defining a back side of the content element, the visual transition comprising a rotation from the first displayable page to the second displayable page, the rotation being about an axis extending in a second direction aligned with the scrolling direction of the content stream. In some embodiments, the second displayable page comprises an input field allowing the user to associate an indication with the content element. In some embodiments, the indication causes the content element to be removed from the content stream. In some embodiments of the method 3100, causing the content element to be removed from the content stream comprises causing, by the processing unit, a collapsing of the content stream to be displayed, the collapsing resulting in juxtaposing an upstream content element with a downstream content element of the content stream, the upstream content element being positioned upstream in the content stream with respect to the content element and the downstream content element being positioned downstream in the content stream with respect to the content element before causing the content element to be removed from the content stream occurs. In some embodiments, the input field comprises at least one of a checklist, a text field and a button and the indication comprises at least one of additional information to be associated with the content element and an action to be executed in connection with the content element. In some embodiments, the axis bisects the first displayable page in a first portion and a second portion, the first portion and the second portion remaining coplanar during the visual transition. In some embodiments, the axis is central with respect to the first displayable page and the second displayable page.

The method 3100 may also comprise a step 3108 and a step 3110. At the step 3108, the method 3100 may receive, from the user, a second gesture input via the touch hardware. The step 3110 comprises causing, by the processing unit, the display on the screen of the electronic device, of a second visual transition from the second displayable page of the content element to the first displayable page of the content element, the second visual transition comprising a second rotation from the second displayable page to the first displayable page, the second rotation being about the axis extending in the second direction aligned with the scrolling direction of the content stream. In some embodiments, a rotation direction of the visual transition is opposite to a rotation direction of the second visual transition and vice-versa.

In some embodiments, the method 3100 may also comprise a first additional step and a second additional step. The first additional step may cause the method 3100 to receive, from the user, a third gesture input via the touch hardware. The second additional step comprises causing, by the processing unit, the display on the screen of the electronic device, of a scrolling of the content stream from the content element to one of an upstream content element and a downstream content element, the upstream content element being positioned upstream in the content stream with respect to the content element and the downstream content element being positioned downstream in the content stream with respect to the content element.

In some embodiments, the content element is associated with an information element and the content stream is an information feed wherein information elements are presented to the user, via the screen, in a sequential fashion.

In some embodiments, the content element represents a media asset and the content stream is a media asset feed. In some embodiments of the method 3100, the gesture input is a swipe gesture comprising a touchdown event, a drag event and a liftoff event. In some embodiments, the screen and the touch hardware define a touch screen. In some embodiments, causing, by the processing unit, the display of the visual transition comprises generating transitional visual representations of the first displayable page and of the second displayable page so as to display, on the screen, a continuous rotation movement to the user.

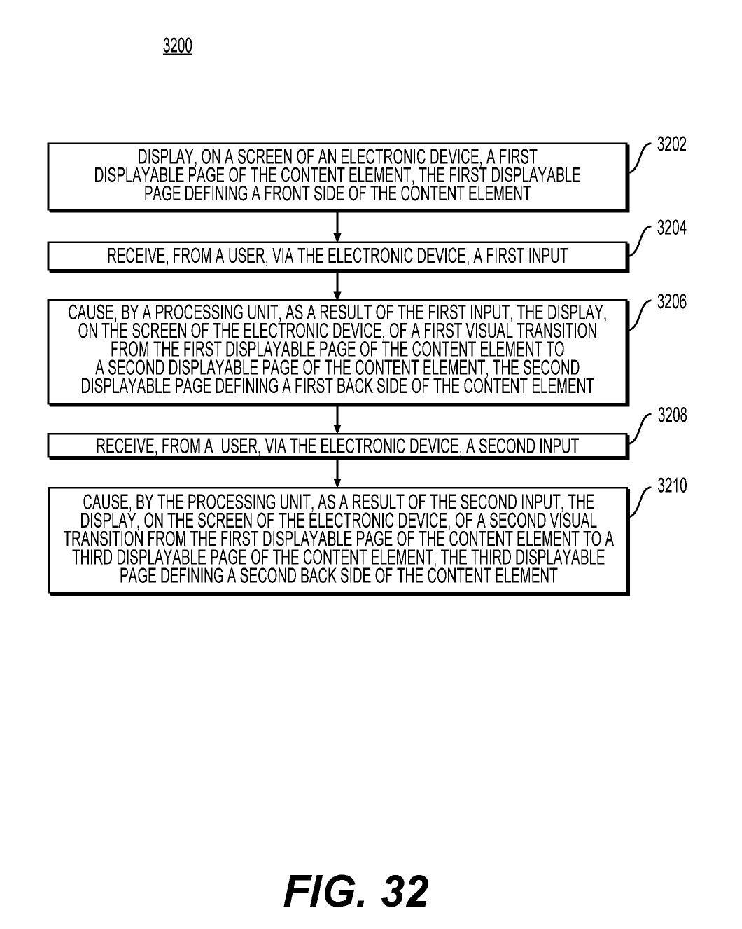

Turning now to FIG. 32, there is shown a flowchart illustrating a third computer-implemented method 3200 of interacting with a content element of a content stream. In some embodiments, the method 3200 may be (completely or partially) implemented on the computer system 100, the electronic device 210 and/or the server 222. As a person skilled in the art of the present technology may appreciate, some or all of the aspects and alternative embodiments recited in connection with the method 3200 may equally be applicable to or adaptable to the methods 3000 and 3100.

The method 3200 starts at a step 3202 by displaying, on a screen of an electronic device, a first displayable page of the content element, the first displayable page defining a front side of the content element.

Then, at a step 3204, the method 3200 may receive, from a user, via the electronic device, a first input.

At a step 3206, the method 3200 executes causing, by a processing unit, as a result of the first input, the display, on the screen of the electronic device, of a first visual transition from the first displayable page of the content element to a second displayable page of the content element, the second displayable page defining a first back side of the content element, the first visual transition comprising a first rotation from the first displayable page to the second displayable page, the first rotation being about an axis extending in a second direction aligned with the scrolling direction of the content stream, the first rotation being along a first rotational direction along the axis. In some embodiments, the first rotational direction is a clockwise direction and the second rotational direction is an anticlockwise direction. In some alternative embodiments, the first rotational direction is an anticlockwise direction and the second rotational direction is a clockwise direction.

In some embodiments, the method 3200 further comprises a step 3208 and a step 3210. The step 3208 comprises receiving, from the user, via the electronic device, a second input, different from the first input. The step 3210 comprises causing, by the processing unit, as a result of the second input, the display, on the screen of the electronic device, of a second visual transition from the first displayable page of the content element to a third displayable page of the content element, the third displayable page defining a second back side of the content element, the second visual transition comprising a second rotation from the first displayable page to the third displayable page, the second rotation being along a second rotational direction along the axis, the second rotational direction being opposite the first rotational direction. In some embodiments, the first input is a first interaction with a first graphical user interface (GUI) component and the second input is a second interaction with a second GUI component, the first GUI component and the second GUI component being displayed on the screen of the electronic device. In some embodiments, the axis bisects the first displayable page in a first portion and a second portion.

In some embodiments of the method 3200, the first GUI component is displayed on the first portion so that the first interaction on the first GUI component initiates the first visual transition thereby reproducing a physical reaction of rotational motion of the first displayable content being pushed on the first portion, the first visual transition including a lifting of the second portion. In some alternative embodiments, the second GUI component is displayed on the second portion so that the second interaction on the second GUI component initiates the second visual transition thereby reproducing a physical reaction of rotational motion of the first displayable content being pushed on the second portion, the second visual transition including a lifting of the first portion.

In some embodiments of the method 3200, the electronic device comprises touch hardware and wherein the first input is a gesture input via the touch hardware, the gesture input being along a first direction perpendicular to a scrolling direction of the content stream. In some embodiments, the gesture input does not require to be “perfectly” along the first direction, some variations and/or irregularity in the gesture input may be deemed acceptable and may qualify as being a gesture input. In some embodiments, the first input is a swipe gesture comprising a touchdown event, a drag event and a liftoff event. In some embodiment of the electronic device, the screen and the touch hardware define a touch screen. In some embodiments, causing, by the processing unit, the display of the first visual transition comprises generating transitional visual representations of the first displayable page and of the second displayable page so as to display, on the screen, a continuous rotation movement to the user. In some embodiments, the second displayable page is associated with an actionable item allowing the user to cause the content element to be removed from the content stream.

In yet some alternative aspects of the method 3200, allowing the user to cause the content element to be removed from the content stream comprises causing, by the processing unit, a collapsing of the content stream to be displayed, the collapsing resulting in juxtaposing an upstream content element with a downstream content element of the content stream, the upstream content element being positioned upstream in the content stream with respect to the content element and the downstream content element being positioned downstream in the content stream with respect to the content element before causing the content element to be removed from the content stream occurs. In some embodiments, the content element represents a media asset and the content stream is a media asset feed. In some embodiments, the first displayable page comprises the media asset and the second displayable page comprises at least one of a checklist, a text field and a button, the at least one of the checklist, the text field and the button allowing the user to associate at least one of additional information with the content element and an action to be executed in connection with the content element. In some embodiments, the action is a providing of a user's feedback in connection with the media asset.

In some alternative embodiments, the first displayable page comprises the media asset and the third displayable page comprises at least one of a checklist, a text field and a button, the at least one of the checklist, the text field and the button allowing the user to associate an action to be executed in connection with the content element. In some embodiments, the action is a sharing of the media asset in a social network associated with the user.

While the above-described implementations have been described and shown with reference to particular steps performed in a particular order, it will be understood that these steps may be combined, sub-divided, or re-ordered without departing from the teachings of the present technology. Accordingly, the order and grouping of the steps is not a limitation of the present technology.

As such, the methods and systems implemented in accordance with some non-limiting embodiments of the present technology can be represented as follows, presented in numbered clauses.

[Clause 1] A computer-implemented method (3200) of interacting with a content element of a content stream, the method comprising:
displaying (3202), on a screen (190) of an electronic device (100, 210, 222), a first displayable page (702) of the content element (302), the first displayable page (702) defining a front side of the content element (302);
receiving (3204), from a user (170), via the electronic device (100, 210, 222), a first input; and
causing (3206), by a processing unit (110, 111), as a result of the first input, the display, on the screen (190) of the electronic device (210), of a first visual transition from the first displayable page (702) of the content element (302) to a second displayable page (902) of the content element (302), the second displayable page (902) defining a first back side of the content element, the first visual transition comprising a first rotation from the first displayable page to the second displayable page, the first rotation being about an axis (710) extending in a second direction aligned with the scrolling direction of the content stream, the first rotation being along a first rotational direction along the axis (710).

[Clause 2] The method (3200) of clause 1, wherein the method (3200) further comprises:
receiving (3208), from the user (170), via the electronic device (210), a second input, different from the first input; and
causing (3210), by the processing unit (110, 111), as a result of the second input, the display, on the screen (190) of the electronic device (210), of a second visual transition from the first displayable page (702) of the content element (302) to a third displayable page (1302) of the content element (302), the third displayable page (1302) defining a second back side of the content element (302), the second visual transition comprising a second rotation from the first displayable page (702) to the third displayable page (1302), the second rotation being along a second rotational direction along the axis (710), the second rotational direction being opposite the first rotational direction.

[Clause 3] The method of any one of clauses 1 and 2, wherein the first rotational direction is a clockwise direction and the second rotational direction is an anticlockwise direction.

[Clause 4] The method of any one of clauses 1 to 3, wherein the first rotational direction is an anticlockwise direction and the second rotational direction is a clockwise direction.

[Clause 5] The method of clause 2, wherein the first input is a first interaction with a first graphical user interface (GUI) component and the second input is a second interaction with a second GUI component, the first GUI component and the second GUI component being displayed on the screen (190) of the electronic device (100, 210, 222).

[Clause 6] The method of clause 5, wherein the axis bisects the first displayable page in a first portion and a second portion.

[Clause 7] The method of clause 6, wherein the first GUI component is displayed on the first portion so that the first interaction on the first GUI component initiates the first visual transition thereby reproducing a physical reaction of rotational motion of the first displayable content being pushed on the first portion, the first visual transition including a lifting of the second portion.

[Clause 8] The method of clause 6, wherein the second GUI component is displayed on the second portion so that the second interaction on the second GUI component initiates the second visual transition thereby reproducing a physical reaction of rotational motion of the first displayable content being pushed on the second portion, the second visual transition including a lifting of the first portion.

[Clause 9] The method of any one of clauses 1 to 8, wherein the electronic device (100, 210, 222) comprises touch hardware (194) and wherein the first input is a gesture input via the touch hardware (194), the gesture input being along a first direction perpendicular to a scrolling direction of the content stream.

[Clause 10] The method of clause 9, wherein the first input is a swipe gesture comprising a touchdown event, a drag event and a liftoff event.

[Clause 11] The method of clause 9, wherein the screen and the touch hardware (194) define a touch screen (190).

[Clause 12] The method of any one of clauses 1 to 11, wherein causing, by the processing unit (110, 111), the display of the first visual transition comprises generating transitional visual representations of the first displayable page (702) and of the second displayable page (902) so as to display, on the screen (190), a continuous rotation movement to the user (170).

[Clause 13] The method of any one of clauses 1 to 12, wherein the second displayable page (902) is associated with an actionable item allowing the user to cause the content element (302) to be removed from the content stream.

[Clause 14] The method of clause 13, wherein allowing the user (170) to cause the content element (302) to be removed from the content stream comprises causing, by the processing unit (110, 111), a collapsing of the content stream to be displayed, the collapsing resulting in juxtaposing an upstream content element with a downstream content element of the content stream, the upstream content element being positioned upstream in the content stream with respect to the content element and the downstream content element being positioned downstream in the content stream with respect to the content element before causing the content element to be removed from the content stream occurs.

[Clause 15] The method of any one of clauses 2 to 14, wherein the content element (302) represents a media asset and the content stream is a media asset feed.

[Clause 16] The method of clause 15, wherein the first displayable page (702) comprises the media asset and the second displayable page comprises at least one of a checklist, a text field and a button, the at least one of the checklist, the text field and the button allowing the user to associate at least one of additional information with the content element and an action to be executed in connection with the content element.

[Clause 17] The method of clause 16, wherein the action is a providing of a user's feedback in connection with the media asset.

[Clause 18] The method of any one of clauses 2 to 17, wherein the first displayable page (702) comprises the media asset and the third displayable page (1302) comprises at least one of a checklist, a text field and a button, the at least one of the checklist, the text field and the button allowing the user to associate an action to be executed in connection with the content element (302).

[Clause 19] The method of clause 18, wherein the action is a sharing of the media asset in a social network associated with the user.

[Clause 20] A computer-implemented method (3100) of interacting with a content element (302) of a content stream, the method (3100) comprising:
displaying (3102), on a screen (190) of an electronic device (100, 210, 222) comprising touch hardware (194), a first displayable page (702) of the content element (302), the first displayable page (702) defining a front side of the content element (302);
receiving (3104), from a user (170), a gesture input via the touch hardware (194), the gesture input being along a first direction perpendicular to a scrolling direction of the content stream; and
causing (3106), by a processing unit (110, 111), the display, on the screen (190) of the electronic device (100, 210, 222), of a visual transition from the first displayable page (702) of the content element (302) to a second displayable page (902) of the content element (302), the second displayable page (902) defining a back side of the content element (302), the visual transition comprising a rotation from the first displayable page (702) to the second displayable page (902), the rotation being about an axis (710) extending in a second direction aligned with the scrolling direction of the content stream.

[Clause 21] The method of clause 20, wherein the second displayable page (902) comprises an input field allowing the user to associate an indication with the content element (302).

[Clause 22] The method of clause 21, wherein the indication causes the content element (302) to be removed from the content stream.

[Clause 23] The method of clause 22, wherein causing the content element (302) to be removed from the content stream comprises causing, by the processing unit (110, 111), a collapsing of the content stream to be displayed, the collapsing resulting in juxtaposing an upstream content element with a downstream content element of the content stream, the upstream content element being positioned upstream in the content stream with respect to the content element (302) and the downstream content element being positioned downstream in the content stream with respect to the content element before causing the content element (302) to be removed from the content stream occurs.

[Clause 24] The method of any one of clauses 21 to 23, wherein the input field comprises at least one of a checklist, a text field and a button and the indication comprises at least one of additional information to be associated with the content element (302) and an action to be executed in connection with the content element (302).

[Clause 25] The method of any one of clauses 20 to 24, wherein the axis bisects the first displayable page (702) in a first portion and a second portion, the first portion and the second portion remaining coplanar during the visual transition.

[Clause 26] The method of any one of clauses 20 to 25, wherein the axis (710) is central with respect to the first displayable page (702) and the second displayable page (902).

[Clause 27] The method of any one of clauses 20 to 26, further comprising:
receiving (3108), from the user (170), a second gesture input via the touch hardware (194); and
causing (3110), by the processing unit (110, 111), the display on the screen (190) of the electronic device (100, 210, 222), of a second visual transition from the second displayable page (902) of the content element (302) to the first displayable page (702) of the content element (302), the second visual transition comprising a second rotation from the second displayable page (902) to the first displayable page (702), the second rotation being about the axis extending in the second direction aligned with the scrolling direction of the content stream.

[Clause 28] The method of clause 27, wherein a rotation direction of the visual transition is opposite to a rotation direction of the second visual transition and vice-versa.

[Clause 29] The method of any one of clauses 20 to 28, further comprising:
receiving, from the user (170), a third gesture input via the touch hardware (194); and
causing, by the processing unit (110, 111), the display on the screen (190) of the electronic device (100, 210, 222), of a scrolling of the content stream from the content element (302) to one of an upstream content element and a downstream content element, the upstream content element being positioned upstream in the content stream with respect to the content element (302) and the downstream content element being positioned downstream in the content stream with respect to the content element (302).

[Clause 30] The method of any one of clauses 20 to 29, wherein the content element (302) is associated with an information element and the content stream is an information feed wherein information elements are presented to the user (170), via the screen (190), in a sequential fashion.

[Clause 31] The method of any one of clauses 20 to 30, wherein the content element (302) represents a media asset and the content stream is a media asset feed.

[Clause 32] The method of any one of clauses 20 to 31, wherein the gesture input is a swipe gesture comprising a touchdown event, a drag event and a liftoff event.

[Clause 33] The method of any one of clauses 20 to 32, wherein the screen (190) and the touch hardware (194) define a touch screen.

[Clause 34] The method of any one of clauses 20 to 33, wherein causing, by the processing unit, the display of the visual transition comprises generating transitional visual representations of the first displayable page (702) and of the second displayable page (902) so as to display, on the screen, a continuous rotation movement to the user.

[Clause 35] A computer-implemented method (3000) of interacting with a content element (302) of a content stream, the method comprising:

displaying (3002), on a screen (190) of an electronic device (100, 210, 222), a first displayable page (702) of the content element (302), the first displayable page (702) defining a front side of the content element (302);

receiving (3004), from a user (170), via the electronic device (100, 210, 222), a first input;

causing (3006), by a processing unit (110, 111), as a result of the first input, the display, on the screen (190) of the electronic device (100, 210, 222), of a first visual transition from the first displayable page (702) of the content element (302) to a second displayable page (902) of the content element (302), the second displayable page defining a first back side of the content element (302);

receiving (3008), from the user (170), via the electronic device (100, 210, 222), a second input different from the first input; and

causing (3010), by the processing unit (110, 111), as a result of the second input, the display, on the screen (190) of the electronic device (100, 210, 222), of a second visual transition from the first displayable page (702) of the content element (302) to a third displayable page (1302) of the content element (302), the third displayable page (1302) defining a second back side of the content element (302).

[Clause 36] The method of clause 35, wherein the first visual transition comprises a first rotation from the first displayable page (702) to the second displayable page (902), the first rotation being about an axis (710) extending in a second direction aligned with the scrolling direction of the content stream, the first rotation being along a first rotational direction along the axis.

[Clause 37] The method of clause 36, the second visual transition comprising a second rotation from the first displayable page (702) to the third displayable page (1302), the second rotation being along a second rotational direction along the axis, the second rotational direction being opposite the first rotational direction.

[Clause 38] The method of clause 36, wherein the first input is a first interaction with a first graphical user interface (GUI) component and the second input is a second interaction with a second GUI component, the first GUI component and the second GUI component being displayed on the screen (190) of the electronic device (100, 210, 222).

[Clause 39] The method of clause 35, wherein the axis bisects the first displayable page (702) in a first portion and a second portion.

[Clause 40] The method of clause 39, wherein the first GUI component is displayed on the first portion so that the first interaction on the first GUI component initiates the first visual transition thereby reproducing a physical reaction of rotational motion of the first displayable content being pushed on the first portion, the first visual transition including a lifting of the second portion.

[Clause 41] The method of clause 39, wherein the second GUI component is displayed on the second portion so that the second interaction on the second GUI component initiates the second visual transition thereby reproducing a physical reaction of rotational motion of the first displayable content being pushed on the second portion, the second visual transition including a lifting of the first portion.

[Clause 42] A computer-implemented system (100, 210, 222) configured to perform the method of any one of clauses 1 to 41.

[Clause 43] A non-transitory computer-readable medium (120, 130), comprising computer-executable instructions that cause a system (100, 210, 222), to execute the method according to any one of clauses 1 to 41.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

What is claimed is:

1. A computer-implemented method of interacting with a content element of a content stream, the method comprising:
displaying, on a screen of an electronic device, a first displayable page of the content element, the first displayable page defining a front side of the content element;
receiving, from a user, via the electronic device, a first input; and
causing, by a processing unit, as a result of the first input, the display, on the screen of the electronic device, of a first visual transition from the first displayable page of the content element to a second displayable page of the content element, the second displayable page defining a first back side of the content element, the first visual transition comprising a first rotation from the first displayable page to the second displayable page, the first rotation being about an axis extending in a second direction aligned with the scrolling direction of the content stream, the first rotation being along a first rotational direction along the axis.

2. The method of claim 1, wherein the method further comprises:
receiving, from the user, via the electronic device, a second input, different from the first input; and
causing, by the processing unit, as a result of the second input, the display, on the screen of the electronic device, of a second visual transition from the first displayable page of the content element to a third displayable page of the content element, the third displayable page defining a second back side of the content element, the second visual transition comprising a second rotation from the first displayable page to the third displayable page, the second rotation being along a second rotational direction along the axis, the second rotational direction being opposite the first rotational direction.

3. The method of claim 2, wherein the first input is a first interaction with a first graphical user interface (GUI) component and the second input is a second interaction with a second GUI component, the first GUI component and the second GUI component being displayed on the screen of the electronic device.

4. The method of claim 3, wherein the axis bisects the first displayable page in a first portion and a second portion.

5. The method of claim 4, wherein the first GUI component is displayed on the first portion so that the first interaction on the first GUI component initiates the first visual transition thereby reproducing a physical reaction of rotational motion of the first displayable content being pushed on the first portion, the first visual transition including a lifting of the second portion.

6. The method of claim 4, wherein the second GUI component is displayed on the second portion so that the second interaction on the second GUI component initiates the second visual transition thereby reproducing a physical reaction of rotational motion of the first displayable content being pushed on the second portion, the second visual transition including a lifting of the first portion.

7. The method of claim 1, wherein the electronic device comprises touch hardware and wherein the first input is a gesture input via the touch hardware, the gesture input being along a first direction perpendicular to a scrolling direction of the content stream.

8. The method of claim 1, wherein causing, by the processing unit, the display of the first visual transition comprises generating transitional visual representations of the first displayable page and of the second displayable page so as to display, on the screen, a continuous rotation movement to the user.

9. The method of claim 1, wherein the second displayable page is associated with an actionable item allowing the user to cause the content element to be removed from the content stream.

10. The method of claim 9, wherein allowing the user to cause the content element to be removed from the content stream comprises causing, by the processing unit, a collapsing of the content stream to be displayed, the collapsing resulting in juxtaposing an upstream content element with a downstream content element of the content stream, the upstream content element being positioned upstream in the content stream with respect to the content element and the downstream content element being positioned downstream in the content stream with respect to the content element before causing the content element to be removed from the content stream occurs.

11. The method of claim 2, wherein the content element represents a media asset and the content stream is a media asset feed.

12. The method of claim 11, wherein the first displayable page comprises the media asset and the second displayable page comprises at least one of a checklist, a text field and a button, the at least one of the checklist, the text field and the button allowing the user to associate at least one of additional information with the content element and an action to be executed in connection with the content element.

13. The method of claim 12, wherein the action is a providing of a user's feedback in connection with the media asset.

14. A computer-implemented method of interacting with a content element of a content stream, the method comprising:
displaying, on a screen of an electronic device comprising touch hardware, a first displayable page of the content element, the first displayable page defining a front side of the content element;
receiving, from a user, a gesture input via the touch hardware, the gesture input being along a first direction perpendicular to a scrolling direction of the content stream; and
causing, by a processing unit, the display, on the screen of the electronic device, of a visual transition from the first displayable page of the content element to a second displayable page of the content element, the second displayable page defining a back side of the content element, the visual transition comprising a rotation from the first displayable page to the second displayable page, the rotation being about an axis extending in a second direction aligned with the scrolling direction of the content stream.

15. The method of claim 14, wherein the second displayable page comprises an input field allowing the user to associate an indication with the content element.

16. The method of claim 15, wherein the indication causes the content element to be removed from the content stream.

17. The method of claim 14, wherein the axis bisects the first displayable page in a first portion and a second portion, the first portion and the second portion remaining coplanar during the visual transition.

18. The method of claim 14, wherein the axis is central with respect to the first displayable page and the second displayable page.

19. The method of claim 14, further comprising:
receiving, from the user, a second gesture input via the touch hardware; and
causing, by the processing unit, the display on the screen of the electronic device, of a second visual transition from the second displayable page of the content element to the first displayable page of the content element, the second visual transition comprising a second rotation from the second displayable page to the first displayable page, the second rotation being about the axis extending in the second direction aligned with the scrolling direction of the content stream.

20. The method of claim 19, wherein a rotation direction of the visual transition is opposite to a rotation direction of the second visual transition and vice-versa.

21. The method of claim 14, further comprising:
receiving, from the user, a third gesture input via the touch hardware; and
causing, by the processing unit, the display on the screen of the electronic device, of a scrolling of the content stream from the content element to one of an upstream content element and a downstream content element, the upstream content element being positioned upstream in the content stream with respect to the content element and the downstream content element being positioned downstream in the content stream with respect to the content element.

22. The method of claim 14, wherein causing, by the processing unit, the display of the visual transition comprises generating transitional visual representations of the first displayable page and of the second displayable page so as to display, on the screen, a continuous rotation movement to the user.

23. A computer-implemented method of interacting with a content element of a content stream, the method comprising:
displaying, on a screen of an electronic device, a first displayable page of the content element, the first displayable page defining a front side of the content element;
receiving, from a user, via the electronic device, a first input;
causing, by a processing unit, as a result of the first input, the display, on the screen of the electronic device, of a first visual transition from the first displayable page of the content element to a second displayable page of the content element, the second displayable page defining a first back side of the content element;
receiving, from the user, via the electronic device, a second input different from the first input; and
causing, by the processing unit, as a result of the second input, the display, on the screen of the electronic device, of a second visual transition from the first displayable page of the content element to a third displayable page of the content element, the third displayable page defining a second back side of the content element.

24. The method of claim 23, wherein the first visual transition comprises a first rotation from the first displayable page to the second displayable page, the first rotation being about an axis extending in a second direction aligned with the scrolling direction of the content stream, the first rotation being along a first rotational direction along the axis.

25. The method of claim 24, the second visual transition comprising a second rotation from the first displayable page to the third displayable page, the second rotation being along a second rotational direction along the axis, the second rotational direction being opposite the first rotational direction.
